(19) United States
(12) Patent Application Publication
(10) Pub. No.: US 2025/0214341 A1
(43) Pub. Date: Jul. 3, 2025

(54) MANUFACTURING METHOD OF LIQUID EJECTION HEAD AND LIQUID EJECTION HEAD

(71) Applicant: CANON KABUSHIKI KAISHA, Tokyo (JP)

(72) Inventor: REI KURASHIMA, Kanagawa (JP)

(21) Appl. No.: 18/984,808

(22) Filed: Dec. 17, 2024

(30) Foreign Application Priority Data
Dec. 28, 2023 (JP) 2023-222826

(51) Int. Cl. B41J 2/16; B41J 2/14

(52) U.S. Cl. CPC B41J 2/161; B41J 2/14233; B41J 2/1628; B41J 2/1631; B41J 2002/14491

(57) ABSTRACT

A manufacturing method of a liquid ejection head including an element substrate including a piezoelectric element including a first electrode, a piezoelectric membrane, and a second electrode on a surface of a substrate in this order, wiring connected to the piezoelectric element, a terminal for supplying an electric signal and connected to the wiring, an inorganic structure arranged at a position not overlapping the piezoelectric element, the wiring, and the terminal when viewed from a direction vertical to the surface of the substrate, and a protection film that covers at least the piezoelectric element, the wiring, and the inorganic structure includes etching the protection film to form a region in which part of the protection film overlapping the piezoelectric element is removed, and to form an opening in which the protection film overlapping the inorganic structure is removed to expose a part of the inorganic structure.

### BACKGROUND

### Field

The present disclosure relates to a manufacturing method of a liquid ejection head and a liquid ejection head.

### Description of the Related Art

In recent years, with the development of the technology of micro electro-mechanical systems (MEMS), a thin-film piezoelectric element that is based on a semiconductor process has been proposed. Examples of major application include an acceleration sensor and a liquid ejection head of an inkjet printer.

Among liquid ejection heads, there has been known a configuration in which an upper layer of a piezoelectric membrane is opened in order to improve ejection performance by increasing a displacement amount of a piezoelectric element. Japanese Patent Application Laid-Open No. 2016-32880 discusses a liquid ejection head having a configuration in which deformation inhibition of a piezoelectric membrane caused by a protection film that covers a membrane-type piezoelectric element is reduced by removing a portion of the protection film that overlaps an upper electrode.

In the liquid ejection head discussed in Japanese Patent Application Laid-Open No. 2016-32880, a protection layer on the piezoelectric membrane is removed and the upper electrode is exposed. In this case, the long-term reliability of the piezoelectric element may be insufficient. In a manufacturing process, the piezoelectric element is covered with a separately provided member and thus sealed. Nevertheless, depending on sealing capability of the separately provided member covering the piezoelectric element, the long-term reliability of the piezoelectric element may be insufficient especially in the case of using water-based ink. In a case where the etching of the protection film covering the piezoelectric element is performed by using vacuum plasma etching, if the upper electrode continues to be exposed to plasma atmosphere, the upper electrode functions as a catalyst, and as a result, the upper electrode may damage the piezoelectric membrane.

Japanese Patent Application Laid-Open No. 2012-196838 discusses a liquid ejection head in which the thickness of a protection film is reduced to the extent that an upper electrode is not exposed in an upper layer of a piezoelectric membrane. With this configuration, it is possible to enhance a displacement amount while maintaining the sealing performance of the piezoelectric element.

As described above, in reducing the thicknesses of a protection film on a piezoelectric element, the control of a removal thickness is important. As the control of a remaining amount of the protection film, for example, there is a method of controlling an etching amount (remaining amount of the film) by calculating an etching rate based on an etching time and managing the etching time. Nevertheless, the method of controlling an etching amount by the control of an etching time sometimes lacks stability because a variation of etching amount itself or a variation among wafers easily occurs due to a change in the state of an etching apparatus. If a remaining amount of a protection film on a piezoelectric element varies, a disadvantage may arise in which a displacement amount of the piezoelectric element varies.

### SUMMARY

The present disclosure is directed to stably reducing a thickness of a protection film covering a membrane-type piezoelectric element, and stably providing a liquid ejection head including a piezoelectric element with a desired displacement amount.

According to an aspect of the present disclosure, a manufacturing method of a liquid ejection head including an element substrate including a piezoelectric element including a first electrode, a piezoelectric membrane, and a second electrode on a surface of a substrate in this order, wiring connected to the piezoelectric element, a terminal for supplying an electric signal for driving the piezoelectric element and connected to the wiring, an inorganic structure arranged at a position not overlapping the piezoelectric element, the wiring, and the terminal when viewed from a direction vertical to the surface of the substrate, and a protection film that covers at least the piezoelectric element, the wiring, and the inorganic structure includes etching the protection film to form a region in which part of the protection film overlapping the piezoelectric element is removed, and to form an opening in which the protection film overlapping the inorganic structure is removed to expose a part of the inorganic structure.

According to another aspect of the present disclosure, a liquid ejection head includes an element substrate including a piezoelectric element including a first electrode, a piezoelectric membrane, and a second electrode on a surface of a substrate in this order, wiring connected to the piezoelectric element, a terminal for supplying an electric signal for driving the piezoelectric element and connected to the wiring, and a protection film that covers at least at least the piezoelectric element and the wiring, wherein the protection film includes a region in which part of the protection film overlapping the piezoelectric element in a direction vertical to the surface of the substrate is removed, and wherein an inorganic structure is arranged at a position not overlapping the piezoelectric element, the wiring, and the terminal when viewed from the direction vertical to the surface of the substrate, and the inorganic structure is exposed from an opening of the protection film.

Further features of the present disclosure will become apparent from the following description of exemplary embodiments with reference to the attached drawings.

### BRIEF DESCRIPTION OF THE DRAWINGS

FIG. 1 is a diagram illustrating an example of a liquid ejection apparatus to which an exemplary embodiment of the present disclosure is applicable.

FIG. 2 is a diagram illustrating a liquid ejection head according to an exemplary embodiment of the present disclosure.

FIG. 3 is a diagram illustrating an example of a liquid ejection unit according to an exemplary embodiment of the present disclosure.

FIG. 4A is a plan view illustrating a flow path configuration of a liquid ejection head according to an exemplary embodiment of the present disclosure, and FIG. 4B is a cross-sectional view illustrating a flow path configuration of a liquid ejection head according to an exemplary embodiment of the present disclosure.

FIG. 5 is a top view of an element substrate according to a first exemplary embodiment.

FIG. 6 is a top view of a piezoelectric element according to the first exemplary embodiment.

FIG. 7 is a cross-sectional view of the piezoelectric element taken along a VII-VII line in FIG. 6.

FIG. 8 is a cross-sectional view of the piezoelectric element taken along a VIII-VIII line in FIG. 6.

FIGS. 9A to 9E are diagrams illustrating a manufacturing process of a piezoelectric element according to an exemplary embodiment of the present disclosure.

FIGS. 10A to 10C are schematic diagrams each illustrating an example of plasma emission intensity in an end point detector (EPD).

FIG. 11 is a cross-sectional view of a detected member according to the first exemplary embodiment.

FIG. 12 is a top view of a piezoelectric element according to a second exemplary embodiment.

FIGS. 13A to 13D are diagrams illustrating a manufacturing process of a detected member according to Example 1.

FIG. 14 is a cross-sectional view of a piezoelectric element according to Example 2.

FIG. 15A is a cross-sectional view of a piezoelectric element according to Example 3, and FIG. 15B is a cross-sectional view of a detected member according to Example 3.

FIG. 16A is a cross-sectional view of a piezoelectric element according to Example 4, and FIG. 16B is a cross-sectional view of a detected member according to Example 4.

FIG. 17 is a top view of a piezoelectric element according to Example 5.

FIG. 18A is a cross-sectional view of a piezoelectric element according to Example 5, and FIG. 18B is a cross-sectional view of a detected member according to Example 5.

FIG. 19 is a cross-sectional view of the piezoelectric element taken along a XIX-XIX line in FIG. 17.

FIG. 20A is a cross-sectional view of a piezoelectric element according to Example 6, and FIG. 20B is a cross-sectional view of a detected member according to Example 6.

FIG. 21A is a cross-sectional view of a piezoelectric element according to Example 7, and FIG. 21B is a cross-sectional view of a detected member according to Example 7.

FIG. 22A is a cross-sectional view of a piezoelectric element according to Example 8, and FIG. 22B is a cross-sectional view of a detected member according to Example 8.

### DESCRIPTION OF THE EMBODIMENTS

Exemplary embodiments of the present disclosure will be described with reference to the drawings. The components having the same function are assigned the same reference numerals, and the repetitive description will be omitted in some cases. Hereinafter, an example in which the present disclosure is applied to a liquid ejection head included in a liquid ejection apparatus serving as an inkjet printer will be described. Nevertheless, the present disclosure is not limited to the exemplary embodiments to be described below, and can be changed within the range conceivable by those skilled in the art, such as other exemplary embodiments, addition, modification, and deletion. Any configuration is included in the scope of the present disclosure as long as the function and the effect of the present disclosure are produced. The components to be described below are mere examples and are not intended to limit the scope of the present disclosure thereto. The present disclosure will be described using specific examples in which a liquid ejection recording head is used, but is not limited to these examples, and various modifications and changes can be made within the scope of the gist of the present disclosure.

### <Configuration of Liquid Ejection Apparatus>

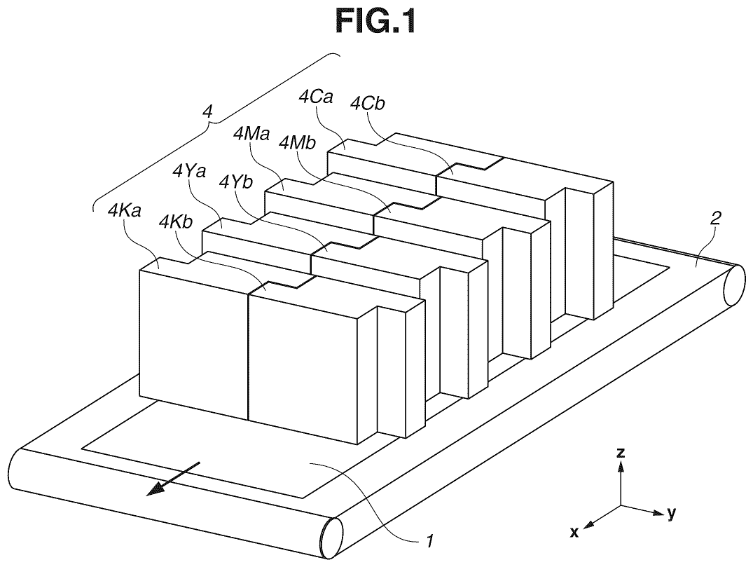

FIG. 1 is a diagram illustrating an example of a configuration of a liquid ejection apparatus according to a first exemplary embodiment. The liquid ejection apparatus illustrated in FIG. 1 is a one-pass type liquid ejection apparatus that records an image by one movement of a medium 1. The liquid ejection apparatus is an example of a liquid ejection apparatus (hereinafter, will also be referred to as an apparatus main body) including a liquid ejection head 4 serving as a full-line head in which an element substrate having ejection ports from which liquid is ejected are arranged over the side corresponding to the entire width of the medium 1. The medium 1 is conveyed by a conveyance unit 2 in a direction indicated by an arrow, and recording is performed on the medium 1 by the liquid ejection head 4. The liquid ejection head according to the present exemplary embodiment can be implemented in any configuration including FIG. 1 and the example of FIG. 1, and the other configurations are not limited. FIG. 1 illustrates a liquid ejection apparatus equipped with eight liquid ejection heads (4Ka, 4Kb, 4Ya, 4Yb, 4Ma, 4Mb, 4Ca, and 4Cb). The positions of the eight liquid ejection heads are determined within the liquid ejection apparatus by a reference member. In FIG. 1, an X direction is a conveyance direction of the medium 1, a Y direction is a width direction of the medium 1, and a Z direction is a direction that intersects with the X direction and the Y direction and is a direction opposite to a direction in which liquid is ejected. In the following description, the Z direction will be also referred to as a height direction.

As described above, the liquid ejection head 4 according to the present exemplary embodiment is a so-called page wide type head of the one-pass type liquid ejection apparatus that has a length corresponding to the width of the medium 1 (size in a direction orthogonal to the conveyance direction of the medium 1). Nevertheless, the present exemplary embodiment can be also applied to a so-called serial-type liquid ejection head that performs recording while scanning on a medium with a liquid ejection head.

As the serial-type liquid ejection head, for example, there is a configuration in which one element substrate for black ink and an element substrate for color ink are mounted. As another example, there is a configuration of a liquid ejection head with a width shorter than a width of a medium, in which several element substrates are arranged in an ejection port array direction in such a manner that their ejection ports overlap each other.

### <Configuration of Liquid Ejection Head>

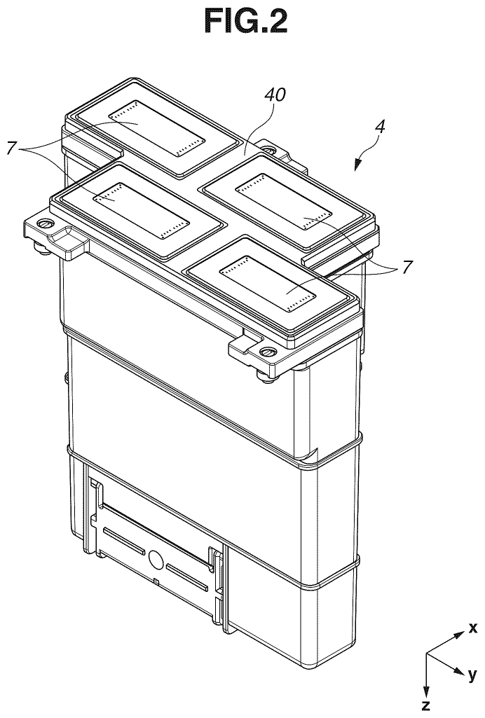

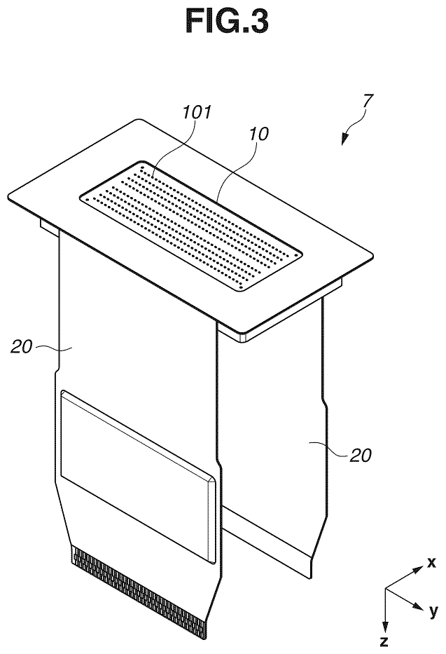

FIG. 2 is a perspective view of the liquid ejection head 4, and FIG. 3 is a perspective view of a liquid ejection unit 7. In the liquid ejection head 4 according to the present exemplary embodiment, a plurality of liquid ejection units 7 each including an element substrate 10 having ejection ports 101 for ejecting liquid is fixed to a support member 40. Even in a liquid ejection head having a configuration in which one liquid ejection unit 7 is fixed to one support member 40, the present exemplary embodiment can be also desirably used.

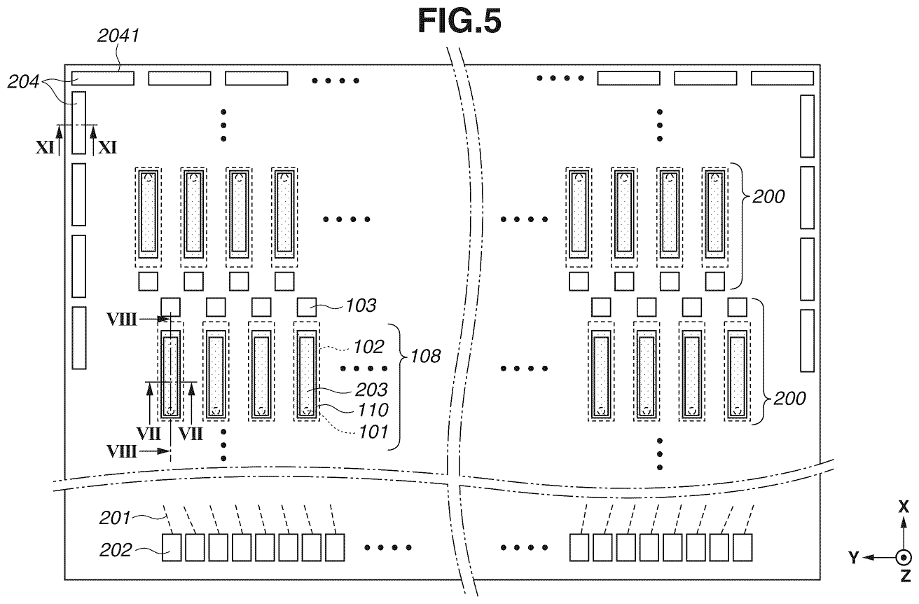

As illustrated in FIG. 2, the plurality of liquid ejection units 7 is arranged in the liquid ejection head 4 in a staggered manner. Each of the liquid ejection units 7 includes about 1000 ejection ports 101 and can perform recording at 1200 dots per inch (dpi). As illustrated in FIG. 3, electrical wiring substrates 20, such as flexible wiring substrates, are connected to the element substrate 10. Each electrical wiring substrate 20 is configured to supply energy or an electric signal for ejecting liquid to the ejection ports 101 and is electrically connected with pad portions 202 (refer to FIG. 5) that are each a terminal of the element substrate 10.

The liquid ejection head 4 includes a supply unit (not illustrated) in which a circulatory flow path for supplying ink supplied from an ink tank included in the liquid ejection apparatus to the liquid ejection unit 7 and collecting ink from the liquid ejection unit 7 is formed. The supply unit is not necessarily to collect ink from the liquid ejection unit 7.

### <Configuration of Element Substrate>

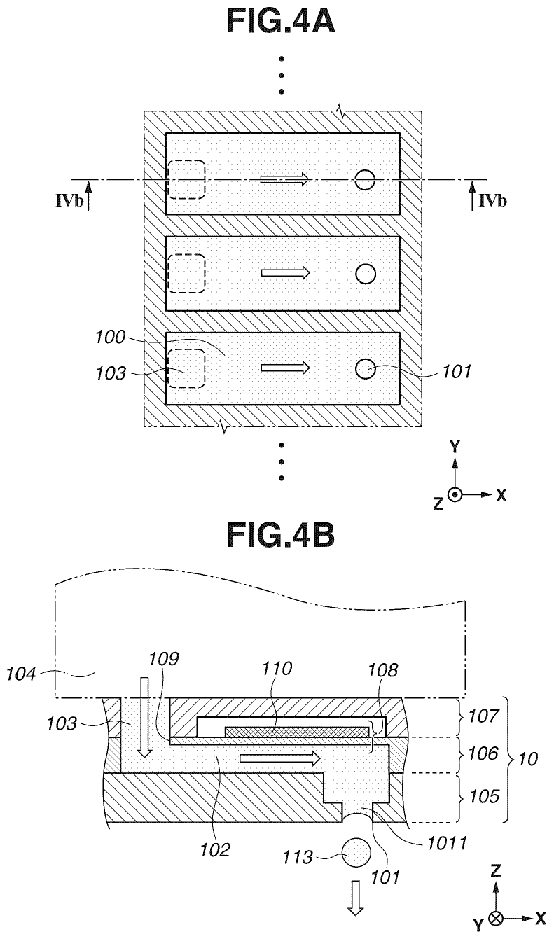

FIGS. 4A and 4B are diagrams illustrating a flow path configuration in the element substrate 10 of the liquid ejection head 4 according to the present exemplary embodiment. FIG. 4A is a top view of the element substrate 10 viewed from the ejection port 101 side, and FIG. 4B is a cross-sectional view of the element substrate 10 taken along a IVb-IVb line in FIG. 4A. The element substrate 10 includes three types of substrates (a first flow path substrate 105, a second flow path substrate 106, and a third flow path substrate 107), and a flow path is formed by combing the substrates. As illustrated in FIG. 4A, a flow path block 100 includes the ejection ports 101 arrayed along the Y direction, and also includes a pressure chamber 102 and a supply flow path 103 that are provided in such a manner as to be communicated with each of the ejection ports 101. Then, each supply flow path 103 connected to a common liquid chamber 104 supplies ink to the pressure chamber 102. Arrows in FIGS. 4A and 4B indicate flows of liquid (hereinafter, will also be referred to as ink). In a case where the first flow path substrate 105, the second flow path substrate 106, and the third flow path substrate 107 are formed using a general-purpose process of a micro electromechanical systems (MEMS), silicon substrates can be used as the three types of substrates. The three types of substrates may be formed by combining silicon substrates using another member, such as a mold.

As illustrated in FIG. 4B, the element substrate 10 according to the present exemplary embodiment is formed by stacking, in the Z direction, the first flow path substrate 105 including the ejection ports 101, the second flow path substrate 106 forming a piezoelectric element 108 and the pressure chamber 102, and the third flow path substrate 107. The third flow path substrate 107 is a substrate that insulates a portion of a piezoelectric membrane 110 of the piezoelectric element 108 from ink and includes a flow path for supplying ink from the common liquid chamber 104 to the pressure chamber 102.

The supply flow path 103, the pressure chamber 102, and the ejection port 101 are formed in such a manner as to correspond to each piezoelectric element 108. Neighboring pressure chambers 102 are partitioned by a partition wall, and are not affected by direct pressure from their neighboring piezoelectric elements 108. Each piezoelectric element 108 is formed adjacent to a vibration plate 109.

Ink stored in the pressure chamber 102 forms a meniscus at the ejection port 101 in a stable state. If a voltage waveform is applied to the piezoelectric element 108 in accordance with an ejection signal, the piezoelectric element 108 deforms and causes the pressure chamber 102 to expand and contract. By combining an expanding operation and a contracting operation, a liquid droplet 113 is generated from the meniscus, and an ink droplet is ejected in the −Z direction.

Ink in the pressure chamber 102 that has been consumed by an ejection operation is supplied from the common liquid chamber 104 by capillary force of the ejection port 101, and a meniscus is formed again at the ejection port 101. In the present exemplary embodiment, an element obtained by combining the ejection port 101, the piezoelectric element 108, and the pressure chamber 102 will be referred to as an ejection element.

Here, the piezoelectric element 108 is an element in which a first electrode 301, the piezoelectric membrane 110, a second electrode 302, and a protection film (sealing film) 304 are formed adjacent to the vibration plate 109. The first electrode 301, the second electrode 302, and a protection film 304 will be described below. The piezoelectric element 108 may include a first insulating film 303 and a second insulating film 604, which will be described below.

An array density of ejection elements in an extending direction (the Y direction) of an ejection port array 200 (refer to FIG. 5) in which a plurality of ejection ports is arrayed may be, for example, 150 nozzle per inch (npi) in the Y direction. The ejection elements may be arranged at the density of 300 npi at which a higher-dense nozzle arrangement is achieved.

As a matter of course, the present exemplary embodiment can be also desirably applied to an array density other than this. The viscosity of ink to be used is approximately several centipoise (cP), and a drive waveform is adjusted in such a manner that the minimum ink ejection amount from each ejection port 101 is several picoliter (pL). In a case where a nozzle density is 300 npi, the width of a liquid chamber is narrow as compared with a case where a nozzle density is 150 npi, and thus, it is considered to ensure a certain displacement amount by designing the vibration plate 109 to be thin.

In the present exemplary embodiment, a drive frequency of each piezoelectric element 108 is set to 30 kilohertz (kHz). The drive frequency of the piezoelectric element 108 is often designed to be about several tens kHz. The drive frequency can be appropriately set based on a time from when ink is actually ejected upon application of a voltage to the piezoelectric element 108 to when the pressure chamber 102 is refilled with ink to enable the next ejection operation in each ejection element. The diameter of the ejection port 101 is adjusted in accordance with the specification of an ejected liquid droplet, and generally, can be selected from the range of about 10 micrometers (μm) to 30 μm. With the above-described configuration, each of the ejection elements arranged on the element substrate 10 ejects ink supplied from an ink supply unit, from the ejection ports 101 in the −Z direction.

FIG. 5 is a diagram illustrating the second flow path substrate 106, and is a top view when viewed from the side on which the piezoelectric elements 108 are arranged. The piezoelectric membranes 110 and the pressure chambers 102 are formed on the second flow path substrate 106, and they can be desirably formed using the MEMS process that uses a silicon substrate.

On the element substrate 10, a plurality of ejection port arrays 200 on which a plurality of ejection ports 101 is arranged along the +Y direction at a desired density and within a range (length of the ejection port array) is arranged along the +X direction. As the number of ejection port arrays 200, an arbitrary number, such as one, two, or eight, can be selected. As the ejection port density, an arbitrary value, such as 150 npi, can be selected, and in a case where the number of ejection ports is large, for example, 300 npi can be selected. The length of the ejection port arrays is generally set to about 0.5 inches or 1.5 inches in a case where the ejection port arrays are long.

On the second flow path substrate 106 included in the element substrate 10 illustrated in FIG. 5, the piezoelectric elements 108 each having a thin-film structure that can expand and contract the volume of the pressure chamber 102 is provided in the pressure chamber 102.

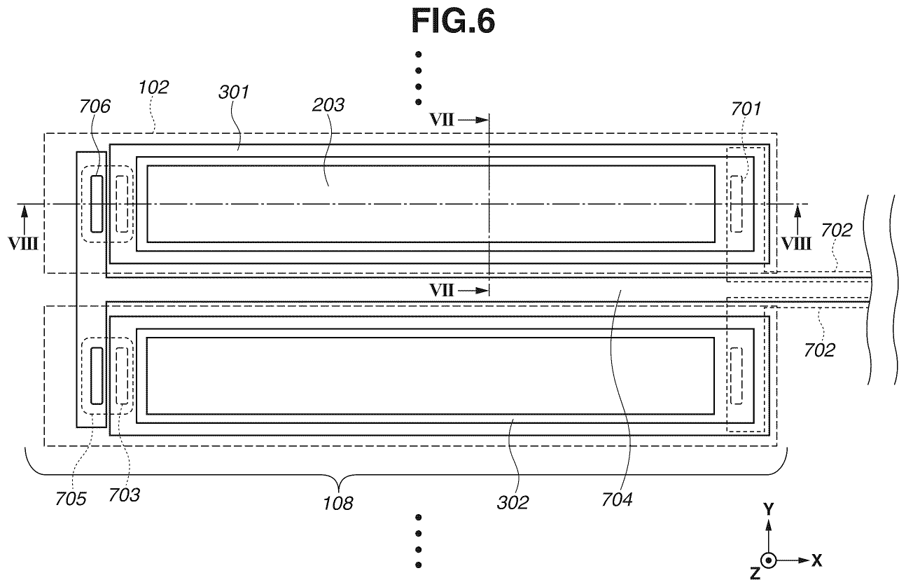

Wires 201 for supplying corresponding electric signals to the first electrode 301 and the second electrode 302 (refer to FIG. 6), which will be described below, and the pad portions 202 for electrically connecting with the electrical wiring substrate 20 such as a flexible wiring substrate are connected to the piezoelectric elements 108. In FIG. 5, the illustration of the wires 201 in a portion other than the connection portions with the pad portions 202 are omitted. The shape of the pad portions 202 can be appropriately selected in accordance with an implementation method. The pad portions 202 may be intensively arranged only on one side of the second flow path substrate 106 as illustrated in FIG. 5, or may be arranged on both sides of the second flow path substrate 106 in a divisional manner.

In a case where the pad portions 202 are intensively arranged on one side of the second flow path substrate 106, there is an advantage that the number of members, such as an electrical wiring substrate, to be mounted on one element substrate, and the number of implementation processes can be reduced. The effect obtained by the reduction of the number of members is larger especially in the case of using a flexible wiring substrate on which an integrated circuit (IC) is mounted, as a member to be mounted. Nevertheless, in a case where the wires 201 and the pad portions 202 are intensively arranged on one side, the density of the wires on the second flow path substrate 106 is high, thereby making the restrictions on the arrangement of the wires 201 severe, and it may be necessary to optimize the arrangement of the wires 201. In this case, the dimensions of a line and a space in a wiring design rule may be set to small values. By employing a stack structure in which the wires 201 are divided and provided to layers, it is also possible to avoid the restriction of a planar arrangement space.

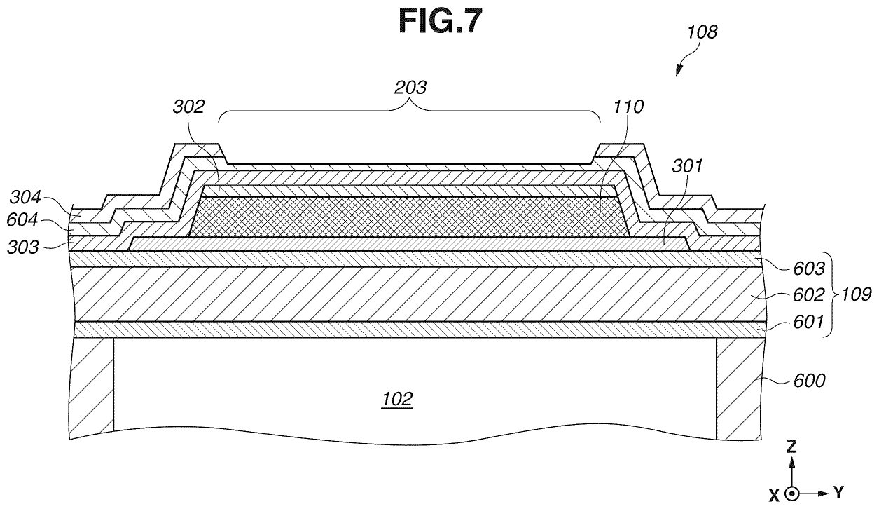

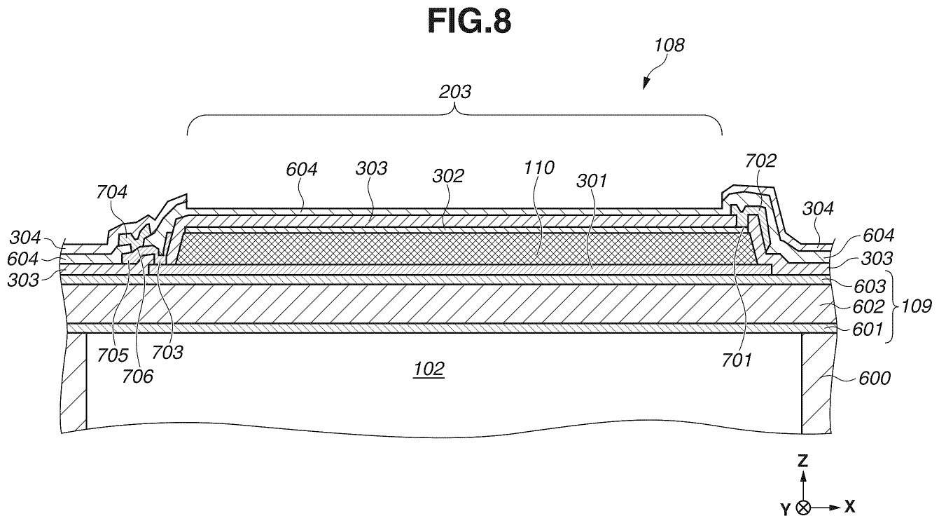

The piezoelectric elements 108 will be described in detail. FIGS. 6 to 8 are diagrams illustrating the piezoelectric elements 108. FIG. 6 is a top view, FIG. 7 is a cross-sectional view taken along a VII-VII line in FIG. 6, and FIG. 8 is a cross-sectional view taken along a VIII-VIII in FIG. 6. As illustrated in FIG. 8, each piezoelectric element 108 has a configuration in which the vibration plate 109, the first electrode 301, the piezoelectric membrane 110, the second electrode 302, the first insulating film 303, second wiring 702, a relay portion 705, the second insulating film 604, first wiring 704, and the protection film 304 are stacked in the order from the side of the pressure chamber 102 formed in a silicon (Si) layer 600 of the second flow path substrate 106. The first insulating film 303 insulates the relay portion 705 and the first electrode 301 in a region other than a contact portion 703, and the second insulating film 604 insulates the relay portion 705 and the first wiring 704 in a region other than a contact portion 706. The protection film 304 is partially opened in a region located above (the +Z direction) the second electrode 302, and a region 203 in which inorganic films (protection films), such as the first insulating film 303 and the protection film 304, that cover the second electrode 302 are reduced in thickness or removed is formed.

The material of the vibration plate 109 can be selected from, for example, silicon nitride film, silicon, metal, and heat resistance glass depending on required machine characteristics and reliability.

Examples of the material of the piezoelectric membrane 110 include an inorganic material, such as an oxide containing lithium and niobium or lithium and tantalum as main components (such as lithium niobate and lithium tantalate), an oxide containing lead and titanium as main components (such as lead titanate), an oxide to which zirconium is further added to this (such as lead zirconate titanate), an oxide containing lead and niobate as main components, an oxide containing barium and titanium as main components (such as barium titanate), a zinc oxide, quartz, an aluminum nitride, and an organic material, such as polylactic acid and polyvinylidene fluoride. Among them, a lead zirconium titanate (PZT) that is an oxide containing lead, zirconium, and titanium as main components and has high displacement efficiency can be desirably used. The thickness of the piezoelectric membrane 110 is determined based on an applied voltage and a piezoelectric property that are required to obtain a desired displacement amount, and is generally about 1 μm to 2 μm. From the viewpoint of controllability, it is desirable to drive the piezoelectric elements 108 using a material with high linearity within a voltage range with high linearity as a response displacement of voltage. Nevertheless, in reality, a saturation property, a hysteresis property, and electrostriction nonlinearity affect a displacement characteristic. A formation method of the piezoelectric membrane 110 can be selected from vacuum sputtering deposition, sol-gel solution deposition, and chemical vacuum deposition (CVD) membrane formation. The piezoelectric membrane 110 often involves calcination after membrane formation. For example, the piezoelectric membrane 110 is calcined at about 600° C. to 800° C. at most in an oxygen atmosphere using lamp annealing. The piezoelectric membrane 110 may be directly formed on the vibration plate 109 and integrally calcined, or the piezoelectric membrane 110 may be formed on another substrate and calcined, and then released from the substrate and transferred to the vibration plate 109. Alternatively, the piezoelectric membrane 110 may be formed on another substrate, released from the substrate and transferred to the vibration plate 109, and then integrally formed.

Because the first electrode 301 may be exposed to high temperature of several hundred degrees ° C. in a calcination process of the piezoelectric membrane 110, the first electrode 301 is desirably made of a noble metal material with a high melting temperature such as platinum (Pt) and iridium (Ir). In a case where the calcination process of the piezoelectric membrane 110 can be separated, a gold (Au) alloy or an aluminum (Al) alloy may be selected.

The second electrode 302 is formed on the piezoelectric membrane 110, and for example, platinum, titanium, tungsten, or an alloy of these can be used. Similarly to the first electrode 301, to improve adhesiveness between the second electrode 302 and the piezoelectric membrane 110, a thin film of titanium or chromium may be included between the second electrode 302 and the piezoelectric membrane 110 as an adhesive layer.

In order to apply a desired voltage between the first electrode 301 and the second electrode 302 and displace the piezoelectric membrane 110, the first wiring 704 is electrically connected to the first electrode 301, and the second wiring 702 is electrically connected to the second electrode 302. This configuration enables the piezoelectric membrane 110 to be supplied with a potential difference based on an electric signal transmitted from the outside. The first wiring 704 and the second wiring 702 may be formed of the same material, or may be formed of different materials. It is desirable that materials to be used in the first wiring 704 and the second wiring 702 are each a conductive material. In order to decrease a probability of an occurrence of wire breakage attributed to electromigration, a material with low electrical resistance is desirably used. Examples of the material include aluminum, copper, and gold. Furthermore, the material may be an alloy containing two or more types of elements of these materials. For example, an Al alloy may be desirably used. For the purpose of improving adhesiveness of the wiring, a film of titanium and chromium may be included between films that are in contact with the first wiring 704 and the second wiring 702.

The relay portion 705 serves as bridge between the first electrode 301 and the first wiring 704. At a contact portion 701, the second electrode 302 and the second wiring 702 are electrically connected. At the contact portion 703, the first electrode 301 and the relay portion 705 are electrically connected. Accordingly, the second wiring 702 and the first wiring 704 are electrically connected via the piezoelectric membrane 110.

In the present exemplary embodiment, a configuration in which wiring (the first wiring 704 and the second wiring 702) are stacked in multiple layers is employed. In a case where, for example, piezoelectric elements are arranged on a substrate at high density, by employing a multilayer configuration of wiring, there is an advantage that a degree of flexibility in the arrangement of piezoelectric elements and wiring increases.

The first insulating film 303 and the second insulating film 604 cover the first electrode 301, the piezoelectric membrane 110, and the second electrode 302, and in the present exemplary embodiment, as an example, a tetra ethoxy silane (TEOS) oxide film (silicon oxide film) is formed. The TEOS oxide film is an example, and the material of the first insulating film 303 and the second insulating film 604 can be selected from general insulator materials, such as silicon nitride, silicon oxynitride, and aluminum oxide. A film stack in which two or more types of different films are stacked may be used. In the formation of the first insulating film 303 and the second insulating film 604, for example, a general film formation method, such as a chemical vacuum deposition method (CVD method) or a sputtering method, can be used. Because of the excellent production rate, in the present exemplary embodiment, TEOS oxide films are formed as the first insulating film 303 and the second insulating film 604 using the CVD method.

In a case where an oxide system ceramic is used as the piezoelectric membrane 110, when silicon oxide films serving as the first insulating film 303 and the second insulating film 604 are formed, the piezoelectric membrane 110 is damaged and a piezoelectric property may deteriorate. For this reason, a protection film for preventing damages to the piezoelectric membrane 110 is desirably formed on the surface of the piezoelectric membrane 110 prior to the formation of the first insulating film 303. As a general insulating film used as the first insulating film 303 and the second insulating film 604, a silicon oxide (SiO) base film formed by a CVD device is often used. At this time, an oxide (the piezoelectric membrane 110) on the side on which the membrane is to be formed may be easily reduced during gas reaction. If the oxide is once reduced, in some cases, the interface of the Schottky junction of the piezoelectric membrane 110 and the second electrode 302 collapses, and the leak property of the piezoelectric membrane 110 deteriorates, leading to a decline in long-term reliability. In order to prevent this, it is effective to form an oxide film, such as an aluminum oxide (Al₂O₃) film, to be formed by an atomic layer deposition (ALD) device, for example, as a protection film for inhibiting the reduction. The film formation that uses ALD is desirable from the viewpoint of a good step coverage property for the piezoelectric membrane 110.

On the other hand, if Al₂O₃ is exposed to moisture in a high-temperature state, its surface alters. In a case where the formation of a contact hole to be described below or a formation process of the first wiring 704 and the second wiring 702 are executed during a manufacturing process in a state in which Al₂O₃ is exposed in the outermost surface, the Al₂O₃ film surface may be exposed to moisture during the cleaning after patterning. If the temperature of the moisture remaining on the Al₂O₃ film surface becomes high at the time of etching or ashing, the Al₂O₃ surface may alter. The altered Al₂O₃ existing on the piezoelectric membrane 110 leads to a decline in its dielectric strength, and may cause a malfunction. For this reason, it is desirable that a silicon nitride (SiN) film as the protection film 304 is formed in contact in such a manner as to cover the Al₂O₃ film serving as a protection film.

As described above, in a piezoelectric element to be used in a liquid ejection head, in a case where a relatively high voltage is applied to obtain a sufficient displacement amount for ejecting liquid and the ejection ports 101 are arranged at high density, a surface density of the piezoelectric elements 108 on the second flow path substrate 106 is high. In a high-humidity environment caused by further ejecting ink under such a condition, a current flows on the piezoelectric element surface, leading to a malfunction. In a piezoelectric actuator to be used in a liquid ejection head for ejecting liquid such as ink, especially the existence of liquid exerts a big influence on the piezoelectric actuator. Thus, the first wiring 704 and the second wiring 702 are coated with the protection film 304 serving as a passivation film with high humidity resistance and a high insulating property. A silicon oxide film, a silicon nitride film, or a silicon oxynitride film can be used as the protection film 304. In particular, a passivation film partially including a silicon nitride film has high humidity resistance as compared with a silicon oxide film, and can obtain sufficient humidity resistance and insulating property even if a film thickness is thinner than in a case where a silicon oxide film is formed as a passivation film. Such a passivation film is therefore desirable because it is less likely to have harmful effects on the displacement characteristic of the piezoelectric actuator. It is desirable that the protection film 304 has higher humidity resistance than the first insulating film 303. The humidity resistances of the two films can be compared using a humidity resistance evaluation method generally used for the above-described moisture intrusion evaluation.

From the viewpoint of the insulating property, it is desirable that the protection film 304 is arranged in such a manner as to cover at least the first wiring 704, the second wiring 702, and the peripheral of the piezoelectric membrane 110, when viewed from a direction vertical to the substrate (the vibration plate 109). The film thickness of the protection film 304 is desirably set to a minimum thickness from the viewpoint of reducing the influence on the displacement characteristic of the piezoelectric element.

Because the piezoelectric elements 108 in the liquid ejection head according to the present exemplary embodiment performs a bending deformation operation, if the film thickness of a layer located above the piezoelectric membrane 110 (the second electrode 302) increases, they become less likely to bend and deform. In order to efficiently cause the piezoelectric elements 108 to bend and deform, it is desirable dispose a neutral surface of each piezoelectric element 108 that is defined by material mechanics, near the interface of the piezoelectric membrane 110 and the vibration plate 109, and desirably at a position slightly closer to the vibration plate 109 side. If the first insulating film 303 is formed in an upper layer of the piezoelectric membrane 110, because the neutral surface shifts toward the inside of the piezoelectric membrane 110, it becomes less likely to deform. In the case of forming the protection film 304 on the surface layer side of the piezoelectric membrane 110, it also becomes less likely to deform. Thus, a film is formed with a required film thickness in a region where an insulating function and a sealing function by the first insulating film 303, the second insulating film 604, and the protection film 304 are required, such as electric contact portions of wiring (the first wiring 704 and the second wiring 702) and electrodes (the first electrode 301 and the second electrode 302), for example. On the other hand, it is desirable that, in other regions above the piezoelectric membrane 110, the film has a minimum film thickness required for sealing. With this configuration, it is possible to improve displacement efficiency of bending deformation of the piezoelectric elements 108. As illustrated in FIG. 7, the piezoelectric elements 108 of the present exemplary embodiment each include the region 203 where the inorganic film located above the second electrode 302 is formed with a reduced thickness. In the present exemplary embodiment illustrated in FIGS. 7 and 8, in the region 203, the protection film 304 located on the outermost surface is removed, and the second insulating film 604 located on the second electrode 302 side of the protection film 304 is formed with a reduced thickness. Even in a configuration in which only the protection film 304 located on the outermost surface is formed with a reduced thickness in the region 203, or in a configuration in which all inorganic films located above the second electrode 302 are removed, the present exemplary embodiment can be desirably used.

### <Manufacturing Method of Piezoelectric Element and Liquid Ejection Head>

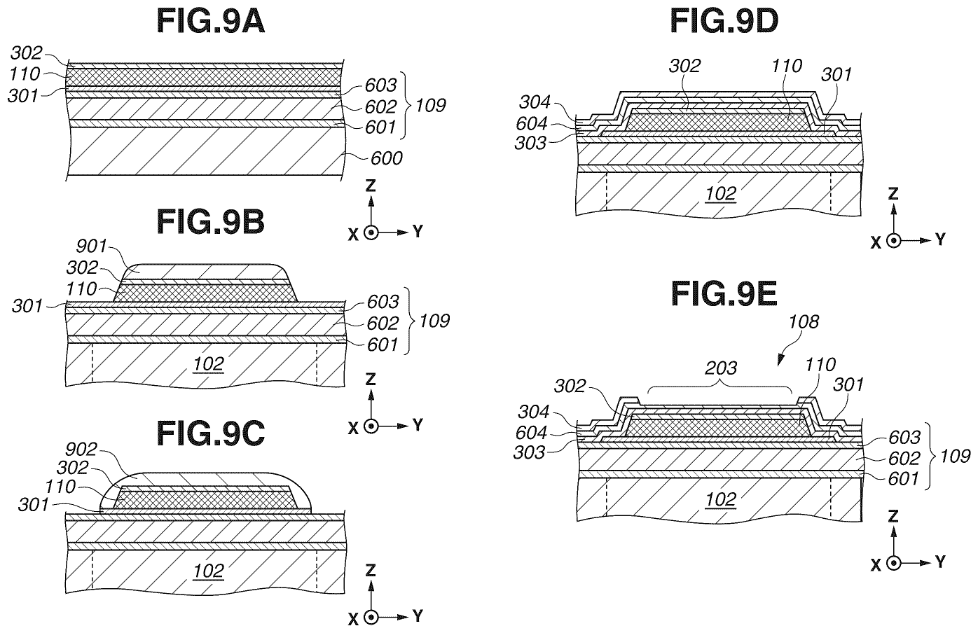

An example of a manufacturing method of the piezoelectric elements 108 with the structure illustrated in FIGS. 6 to 8 will be described with reference to FIGS. 9A to 9E. First of all, as illustrated in FIG. 9A, a silicon on insulator (SOI) substrate that is to serve as the vibration plate 109 is prepared, and a silicon thermally oxidized film (oxide film 603) serving as an insulating layer is formed by a wet oxidation method that uses oxygen and hydrogen gas. In the present exemplary embodiment, each piezoelectric element 108 includes a handle layer (Si layer) 600, an SOI substrate, in which the thickness of a buried oxide (BOX) layer 601 is 0.5 μm to 1.0 μm, and the thickness of a device layer (Si layer) 602 is 0.75 μm to 1.25 μm is used, and the thickness of the oxide film 603 is set to 250 nanometers (nm). A stack film of Pt/TiO₂/Ti is formed on the oxide film 603 as the first electrode 301. Next, by using a sol-gel manufacturing method, a PZT film with a thickness of 1.5 μm to 2.5 μm is formed as the piezoelectric membrane 110. Subsequently, a titanium (Ti)-system alloy film is formed as the second electrode 302.

After that, as illustrated in FIG. 9B, a resist pattern 901 corresponding to the piezoelectric element 108 is formed by photolithography processing. By etching the second electrode 302 and the piezoelectric membrane 110, the second electrode 302 and the piezoelectric membrane 110 in a region not protected by the resist pattern 901 are removed. Each piezoelectric element 108 is formed at a position corresponding to the pressure chamber 102 to be formed in a flow path formation process to be described below. In the present exemplary embodiment, as the size of the piezoelectric membrane 110 film, a length in a shorter direction (the Y direction) is set to 45 μm to 50 μm, and a length in a longer direction (the X direction) is set to 500 μm to 650 μm. After that, the resist pattern 901 is removed. For the removal of the resist pattern 901, for example, plasm ashing and organic stripper cleaning can be used. In FIG. 9B to 9E to be described below, a portion in which the pressure chamber 102 is to be formed is indicated by a dotted line.

Subsequently, as illustrated in FIG. 9C, a resist pattern 902 for patterning the first electrode 301 is formed by photolithography processing. In the present exemplary embodiment, in directions parallel to the surface of the vibration plate 109 (the X direction and the Y direction), the resist pattern 902 is formed widely by about several μm to 10 μm from a region in which the piezoelectric membrane 110 is formed. Subsequently, the pattern of the first electrode 301 is formed by etching a layer that is to serve as the layer of the first electrode 301. After that, the resist pattern 901 is removed.

Next, as illustrated in FIG. 9D, as a protection film for inhibiting the reduction of the piezoelectric membrane 110, an Al₂O₃ film (not illustrated) with a thickness of about 20 nm is formed. After that, a TEOS oxide film with a thickness of about 400 nm is formed as the first insulating film 303. Next, the electric contact portions illustrated in FIGS. 6 and 8 are formed. The contact portion (contact hole) 701 at which the second electrode 302 and the second wiring 702 are electrically connected is formed, and next, the contact portion (contact hole) 703 at which the first electrode 301 and the first wiring 704 are electrically connected is formed.

After that, an Al—Cu alloy film is formed, and the second wiring 702, the relay portion 705 serving as a bridge between the first wiring 704 and the first electrode 301 are simultaneously formed by a series of semiconductor processes. Next, a TEOS oxide film with a thickness of 400 nm is formed as the second insulating film 604 for preventing leak between wiring, and the contact portion (contact hole) 706 is formed in the second insulating film 604 above a region of the relay portion 705 that is electrically connected with the first electrode 301 (refer to FIG. 8).

In the present exemplary embodiment, each pad portion 202 (refer to FIG. 5) is desired to be located on an upper layer of the second insulating film 604 (lower layer of the protection film 304) in a direction vertical to the surface of the vibration plate 109. Thus, in order to connect, to the lower layer of the protection film 304, the second wiring 702 located in a lower layer of the second insulating film 604 at the contact portion 701, an opening (not illustrated) for pad connection is formed in the second insulating film 604 near the pad portion 202. Subsequently, an Al—Cu alloy film that is to serve as the first wiring 704 is formed, and the first wiring 704 is formed by a series of semiconductor processes. The first wiring 704 of a second layer that is electrically connected with the first electrode 301 via the relay portion 705 is thereby formed. At the same time, another wire located in the second layer that electrically connects the second wiring 702 of a first layer that is electrically connected with the second electrode 302 to the pad portion 202 is formed. In this manner, the wire 201 corresponding to the first electrode 301 and the second electrode 302 is electrically connected to the pad portion 202. In this manner, the wire 201 (refer to FIG. 2) corresponding to the first electrode 301 and the second electrode 302 is electrically connected to the pad portion 202, and a configuration in which wiring is stacked in multiple layers is realized. After that, a SiN film with a thickness of about 200 nm is formed as the protection film 304 above the second insulating film 604 that is the outermost layer.

After that, as illustrated in FIG. 9E, the protection film 304 and the second insulating film 604 serving as layers of the inorganic films located above the second electrode 302 of the piezoelectric membrane 110 are partially removed, and the region 203 where the thicknesses of the inorganic films are thinner than other portions is formed above the piezoelectric membrane 110. A formation method of the region 203 will be described below. Lastly, the protection film 304 and the second insulating film 604 that are the inorganic films above the pad portion 202 are removed, and a metal surface of the pad portion 202 is exposed. Through the above-described processes, the piezoelectric element 108 is completed.

Subsequently, in the Si layer 600 of the second flow path substrate 106, photolithography processing is performed from the rear surface side of a region where the piezoelectric membrane 110 is formed, and the pressure chamber 102 and a flow path are formed by deep Si etching that uses inductively coupled plasma (ICP) (refer to FIG. 1). Finally, by bonding the first flow path substrate 105, the second flow path substrate 106, and the third flow path substrate 107 using an adhesive, the element substrate 10 including the piezoelectric elements 108 is completed.

After that, by performing necessary electrical mounting with the electrical wiring substrate 20, and bonding them to the supply unit, a liquid ejection head is formed.

### <Removal of Inorganic Film Above Piezoelectric Membrane>

A formation method of the region 203 where a film located above the second electrode 302 is at least partially removed will be described below. The region 203 can be formed by a masking process that uses a photoresist by photolithography processing, and a removal process by semiconductor plasma etching. A formation process of the region 203 may be performed after the formation of the protection film 304, or may be performed simultaneously with a process of forming an opening for the pad portion 202 (exposure process).

For the formation of the region 203, a method of controlling an etching amount (remaining film amount) by calculating an etching rate and managing an etching time has been conventionally employed. Nevertheless, in the method of controlling an etching amount by the control of an etching time, a variation of etching amount itself or a variation among different wafers easily occurs due to a change of the state of an etching apparatus. The etching rate is easily affected by an inner wall state of a chamber, the atmosphere inside the chamber, and plasma stability. Thus, in the case of controlling an end timing of an etching time based on the etching time, as compared with the present exemplary embodiment that uses a detected member 204, a reduced-film amount (remaining film amount) of an inorganic film in the region 203 easily varies.

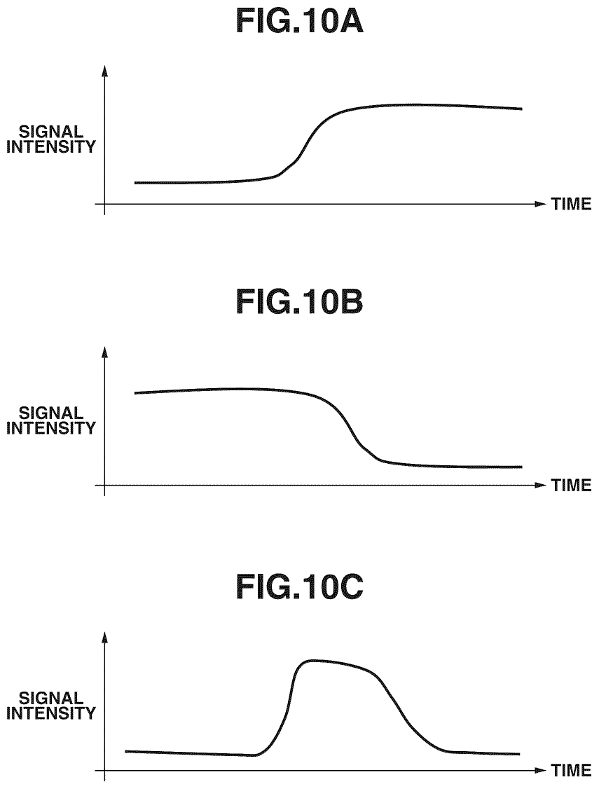

In order to solve this disadvantage, the inventors of the present disclosure have focused attention on an end point detector (EPD) generally mounted on a semiconductor plasma etching device. The EPD is a mechanism for selecting a reacting species desired to be noted, by dispersing a plasma emission spectrum during plasma etching, and recognizing reaction start and reaction end timings of the reacting species. FIGS. 10A to 10C each illustrate an example of a waveform detected by the EPD. A horizontal axis indicates a time, and a vertical axis indicates a signal intensity. For example, in a case where the etching of a specific material is started, an increase in signal intensity as illustrated in FIG. 10A is detected. In a situation where ongoing etching of a specific material ends, a decrease in signal intensity as illustrated in FIG. 10B is detected. Furthermore, in a case where a specific material exists as a thin film, as illustrated in FIG. 10C, a decrease in signal intensity is detected after the signal intensity increase, i.e., a peak is detected, and the decrease in signal intensity means the end of etching of the thin film. More specifically, a stable end point is determined using numerical determination that includes a first-order differential coefficient near the peak shape and even a second-order differential coefficient.

In the present exemplary embodiment, with a view to suppressing a variation in removal thickness when removing at least part of an inorganic film in an upper layer of the second electrode 302, the detected member 204 serving as a member detectable by the EPD is arranged on the second flow path substrate 106. The detected member 204 is an inorganic structure.

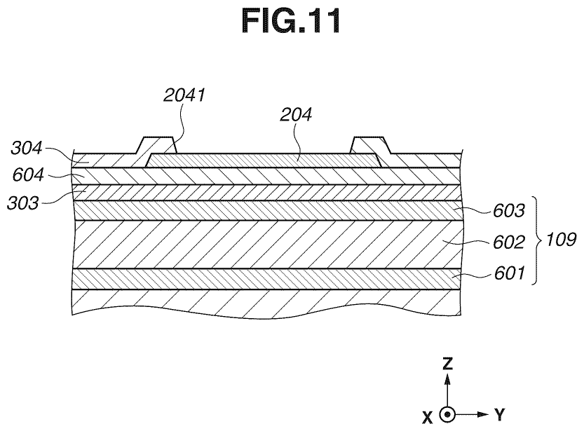

In the present exemplary embodiment, as illustrated in FIG. 5, a plurality of detected members 204 is arranged near the outer peripheral portion of the second flow path substrate 106. FIG. 11 illustrates a cross-sectional view of the second flow path substrate 106 near the detected member 204 that is taken along an XI-XI line in FIG. 5. The first insulating film 303, the second insulating film 604, the detected member 204, and the protection film 304 are stacked on the vibration plate 109 in this order. Similarly to the second electrode 302, the protection film 304 is formed on the detected member 204. For this reason, in an etching process of the protection film 304, the etching is ended upon determining that the protection film 304 has been removed at a time point at which a component originating from the detected member 204 is detected by the EPD, whereby it is possible to form the region 203 with good reproducibility of a removal thickness. That is, if the EPD detects a wavelength component of plasma emission in etching, it is possible to acquire an etching end determination timing. FIG. 11 illustrates a structure near the detected member 204 after the formation of the region 203, and in the protection film 304, an opening 2041 for exposing the detected member 204 is formed in a region in an upper layer of the detected member 204. In the present exemplary embodiment illustrated in FIG. 5, the detected members 204 are arranged near the outer peripheral portion of the second flow path substrate 106, but the arrangement is not limited to this. For example, the detected members 204 may be arranged in a singulation region in clipping and singulating one element substrate 10.

In an etching process of the protection film 304 and the second insulating film 604 that form the region 203, any of cesium fluoride (CF) gas, sulfur fluoride (SF) gas, and chlorine-based gas is often used as main etching gas. The detected member 204 is to be formed of a material to be etched by etching gas to be used in the etching process. For this reason, by the combination with etching gas, for example, Au, Al, Pt, Ir, an Al compound, a Ti compound, a tantalum (Ta) compound, or a tungsten (W) compound can be used as the material of the detected member 204. In a case where chlorine-based gas is used as etching gas, it is necessary to avoid generation of a foreign matter corroded due to reaction products, so that it is desirable to surely remove residual chlorine by further performing aqueous cleaning immediately after etching.

The process of forming the detected member 204 may be provided as an independent process, or may be provided using a process of forming the piezoelectric element 108. In the case of using the above-described process of forming the piezoelectric element 108, providing the detected member 204 does not increase the number of processes, which is thus desirable. In the case of forming the detected member 204 using the process of forming the piezoelectric element 108, the detected member 204 can be formed using a layer that forms the first electrode 301 or the wiring (the first wiring 704 or the second wiring 702). In a case where the detected member 204 is formed using a layer that forms the first electrode 301, a timing at which all inorganic films (the protection film 304, the second insulating film 604, and the first insulating film 303) on an upper layer of the piezoelectric membrane 110 are removed can be detected. In a case where the detected member 204 is formed using a layer that forms the first wiring 704, a timing at which the protection film 304 located in an upper layer of the first wiring 704 is removed can be detected. In a case where the detected member 204 is formed using a layer that forms the second wiring 702, a timing at which the protection film 304 and the second insulating film 604 located in an upper layer of the second wiring 702 are removed can be detected.

As a control method of a removal thickness of an inorganic film in the region 203, an area of the detected member 204 to be exposed to the atmosphere of etching gas, i.e., an area of the opening 2041 for exposing the detected member 204, can be adjusted. An area of the region 203 where at least part of an inorganic film in the layer of the second electrode 302 in one piezoelectric element 108 is removed is denoted by A, and an exposed area of one detected member 204 is denoted by B. If B/A is about 1, an etching rate is considered to progress equally in the detected member 204 and the region 203. Thus, by detecting an exposure timing of the detected member 204 by the EPD, an inorganic film in the upper layer of the second electrode 302 can also be processed equally to the upper layer of the detected member 204. In this case, an exposed area of the detected member 204 from one opening 2041 of the inorganic film in a direction parallel to the surface of the vibration plate 109 is desirably 0.5 times or more and 2 times or less of the area of the region 203, and is more desirably 0.75 times or more and 1.25 times or less.

If B/A is smaller than 1, contribution of etching involving not only physical sputtering in plasma etching but also chemical reaction is larger, and an etching rate of the detected member 204 is relatively faster. Thus, it is possible to make an adjustment in such a manner as to leave an inorganic film on the piezoelectric membrane 110 within the thickness range of the inorganic film in the upper layer of the detected member 204.

On the other hand, if the opening area ratio B/A is larger than 1, an etching rate on the detected member 204 side is relatively slower. Thus, it is possible to etch the inorganic film on the piezoelectric membrane 110 to the thickness of the inorganic film on the detected member 204 or more.

In this manner, by utilizing the dependency of an etching rate on an opening area, it is possible to adjust an etching amount of the inorganic film in the upper layer of the second electrode 302 irrespective of restrictions on the arrangement of the detected member 204 in a direction vertical to the surface of the second flow path substrate 106 in the stack structure of the second flow path substrate 106.

That is, it is possible to adjust a remaining thickness of the inorganic film in the region 203.

It is desirable that the second flow path substrate 106 includes a plurality of detected members 204, and a percentage of a total exposed area of the plurality of detected members 204 relative to an area of the surface of one second flow path substrate 106 on which the piezoelectric elements 108 are formed is 5% or more. Alternatively, it is desirable that a percentage of a total exposed area of the plurality of detected members 204 relative to a total area of the regions 203 of a plurality of piezoelectric elements 108 included in one second flow path substrate 106 is ¼ or more. This is because, if the total exposed area of the detected members 204 is too small, signal-to-noise (S/N) of emission intensity from etching reaction included in plasma emission is insufficient, and the detection by the EPD is difficult. As the arrangement of a plurality of detected members 204, it is desirable that the plurality of detected members 204 is arranged at arrangement density close to the arrangement density of the piezoelectric membranes 110.

A second exemplary embodiment will be described. In the following description, a point different from the above-described first exemplary embodiment will be mainly described, and the description of a part similar to the configuration of the first exemplary embodiment will be omitted.

In the present exemplary embodiment, the removal of at least part of an inorganic film in the upper layer of the second electrode 302, and the removal of an inorganic film in the upper layer of the pad portion 202 serving as an electrical connection portion are simultaneously performed. This produces an advantage that the number of manufacturing processes of an element substrate and a liquid ejection head can be reduced.

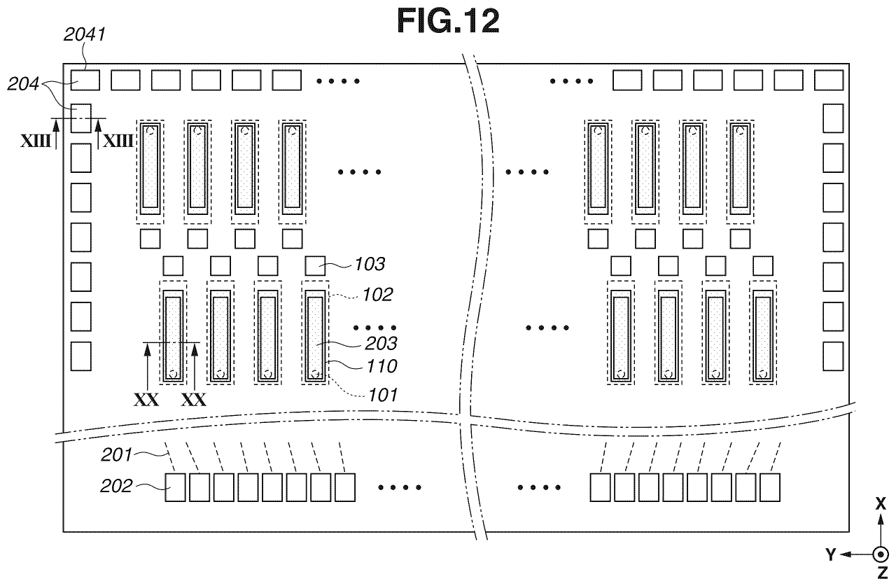

FIG. 12 is a diagram illustrating the second flow path substrate 106, and is a top view of the second flow path substrate 106 when viewed from the side on which the piezoelectric elements 108 are arranged. A plurality of detected members 204 is arranged in a line in the periphery of the element substrate 10.

If the pad portions 202 are formed by using the same layer for forming wiring (the first wiring 704 and the second wiring 702), an increase in the number of manufacturing processes that is caused by providing the detected members 204 is prevented. As the material for forming the wiring and the detected members 204, for example, an Al alloy or an Al alloy with barrier metal can be used.

The element substrate 10 includes the detected members 204, and thus, the S/N of spectrum for detecting the end of etching to expose the pad portion 202 from the inorganic film increases. It is therefore possible to accurately detect a timing at which the pad portion 202 is exposed. It is desirable that an exposed area of each detected member 204 is substantially equal to an exposed area of one pad portion 202 from the inorganic film. More specifically, an exposed area of the detected member 204 from one opening 2041 of the inorganic film in the direction parallel to the surface of the vibration plate 109 is desirably 0.5 times or more and 2 times or less of the area of the pad portion 202, and is more desirably 0.75 times or more and 1.25 times or less.

### EXAMPLE

As an example of the present exemplary embodiment, a piezoelectric element (piezoelectric actuator) serving as a microscopic structure to be manufactured using a semiconductor process, and a liquid ejection head that uses the piezoelectric elements will be described with reference to the drawings. Hereinafter, a configuration and a manufacturing method of the second flow path substrate 106 will be mainly described.

The components to be described in the following examples are merely examples and are not intended to limit the scope of the present disclosure. The present disclosure will be described based on specific examples that use a liquid ejection head, but is not limited to these examples, and various modifications and changes can be made within the gist of the present disclosure.

### Example 1

In this example, the element substrate and the liquid ejection head described in the first exemplary embodiment are created, and the configuration illustrated in FIGS. 5 to 8 is employed.

Individual ejection elements in this example are arrayed in the Y direction at the density of 300 npi.

As the size of each piezoelectric element 108, the size in the X direction (length) is about 700 μm, the size in the Y direction (width) is 50 μm, a diameter of the ejection port 101 is 20 μm, the thickness of a nozzle 1011 communicating with the ejection port 101 is 30 μm, and the thickness of the first flow path substrate 105 is 100 μm. As the size of the pressure chamber 102, the size in the X direction (length) is 750 μm, the size in the Y direction (width) is 55 μm, and the size in the Z direction (height) is 100 μm. The array density of ejection elements is set to 300 npi, and thus, as compared with 150 npi that is the general density of ejection elements in a piezo liquid ejection head according to a conventional art, the width of the pressure chamber 102 is narrow. Thus, by forming the region 203 and designing the vibration plate 109 to be thin, a displacement amount of the piezoelectric element 108 that is required for liquid ejection is desired to be ensured.

In Example 1, the detected member 204 having the configuration illustrated in FIG. 11 is simultaneously formed in the process of forming the piezoelectric element 108. More specifically, the detected member 204 is formed using a layer that forms the first wiring 704 located between the protection film 304 and the second insulating film 604. It therefore makes it possible to detect a timing at which the protection film 304 is removed in the region 203.

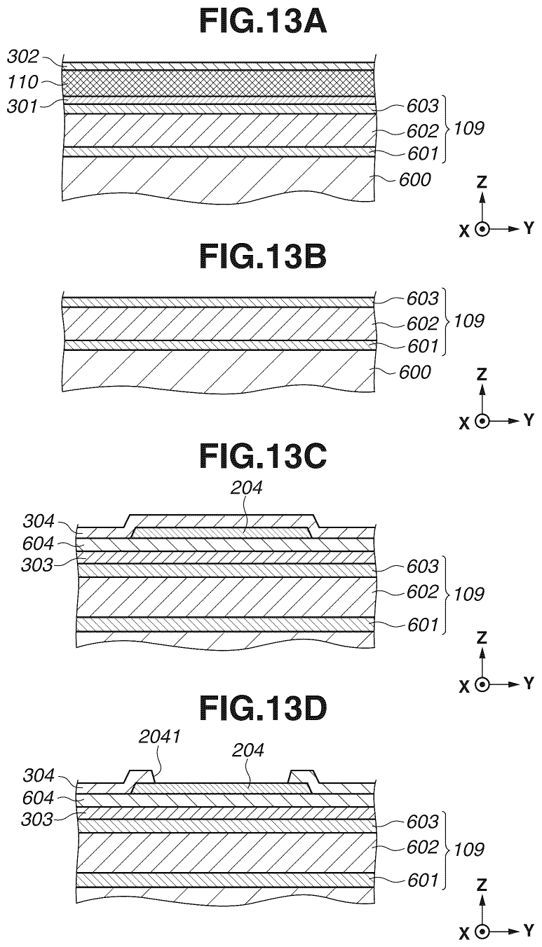

A formation process of the detected member 204 will be described with reference to FIGS. 13A to 13D and 9A to 9E. Cross-sectional views in FIGS. 13A to 13D are cross-sectional views at a position corresponding to the XI-XI line in FIG. 5. First of all, as illustrated in FIGS. 13A and 9A, a layer that is to be the first electrode 301, the piezoelectric membrane 110, and the second electrode 302 is formed over the entire surface of a substrate that is to be the vibration plate 109. After that, as illustrated in FIGS. 13B and 9C, the piezoelectric element 108 is formed by etching the layer that is to be the first electrode 301, the piezoelectric membrane 110, and the second electrode 302, and in a region in which the piezoelectric element 108 is not to be formed, these layers are removed.

Next, a TEOS oxide film with a thickness of 400 nm is formed on the vibration plate 109 as the first insulating film 303, a TEOS oxide film with a thickness of 200 nm is formed as the second wiring 702 and the second insulating film 604, and a layer that is to be the first wiring 704 is formed. By the etching of the layer that is to be the first wiring 704, the first wiring 704 and the detected member 204 are formed. The first wiring 704 and the detected member 204 are formed using an Al—Cu alloy film. After that, by forming a SiN film with a thickness of about 200 nm as the protection film 304, the state illustrated in FIGS. 13C and 9D is obtained.

Subsequently, as illustrated in FIG. 9E, the region 203 is formed by removing part of the inorganic film in the upper layer of the second electrode 302. In this process, as illustrated in FIG. 13D, the etching of the upper layer (the protection film 304) of the detected member 204 is simultaneously performed, and the opening 2041 is formed to expose the detected member 204. In this example, chlorine-based etching gas is used. At the stage where the Al—Cu alloy film is exposed from the opening portion of the detected member 204 by etching, and the etching of the Al—Cu alloy film is started, the signal intensity of plasma emission originating from Al starts to increase. At the stage where the signal intensity of Al is stabilized, etching is ended after the state is maintained for about 10 sec.

In this example, as illustrated in FIG. 5, a plurality of detected members 204 is arranged in the periphery of the second flow path substrate 106. An exposed area from the opening 2041 of one detected member 204 is set to about 1.5 times of the area of the region 203. Accordingly, because the area of the region 203 is narrower than the exposed area of the detected member 204 at the opening 2041, an etching rate of the region 203 is relatively faster than an etching rate of the opening 2041. For this reason, in the region 203 above the second electrode 302, the inorganic films (the protection film 304 and the second insulating film 604) can be removed by a thickness greater than the thickness of the layer (i.e., the protection film 304) formed on the detected member 204. Here, a configuration in which the SiN film of the protection film 304 is removed by a thickness of 200 nm, the TEOS oxide film of the second insulating film 604 is removed by a thickness of 200 nm, and the TEOS oxide film of the second insulating film 604 that has a thickness of 200 nm, and the TEOS oxide film of the first insulating film 303 that has a thickness of 400 nm remain on the second electrode 302 is obtained with good reproducibility. In this manner, by performing etching end point determination using the detected member 204, the reducing amount of the inorganic film on the second electrode 302 (the piezoelectric membrane 110) is stabilized, and repetitive reproducibility of the decreasing amount is high in other wafers.

Because chlorine-based gas is used in the etching in this example, the removal of chlorine components is performed. After the end of etching using chlorine-based gas, resist ashing is performed, and then two-fluid cleaning is sufficiently performed so as to completely remove the chlorine components. After that, the pad portion 202 is opened using a series of semiconductor processes. On the pad portion 202, an Au film for performing good electrical mounting with the electrical wiring substrate 20 is formed by plating growth at a thickness of 1 μm (not shown).

Subsequently, a series of semiconductor processes is performed from the rear surface side of the second flow path substrate 106, and the pressure chamber 102 and a flow path are formed on the second flow path substrate 106 by deep Si etching that uses ICP. After that, the first flow path substrate 105, the second flow path substrate 106, and the third flow path substrate 107 that are formed in a different process are bonded using an adhesive, and then the element substrate 10 including the piezoelectric elements 108 is completed.

After that, by performing necessary electrical mounting and bonding a module serving as an ink supply unit and the element substrate 10 using an adhesive, a liquid ejection head is formed.

### Example 2

In this example, an element substrate and a liquid ejection head described in the first exemplary embodiment are created. In the following description, a point different from Example 1 described above will be mainly described, and the description of a part similar to the configuration of Example 1 will be omitted.

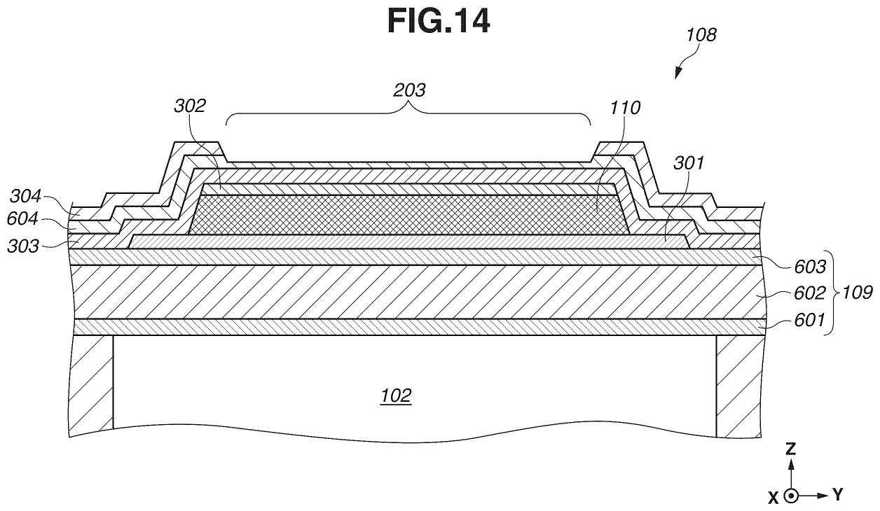

FIG. 14 is a cross-sectional view of the piezoelectric element 108 of this example. The cross-sectional view of the piezoelectric element 108 in FIG. 14 is a cross-sectional view at a position corresponding to the VII-VII line in FIG. 5.

Unlike Example 1, an exposed area of one detected member 204 is equal to the area of the region 203. In a dry etching process of forming the region 203 by reducing the thickness of the inorganic film in the upper layer of the second electrode 302, CF-based etching gas is used. Similarly to Example 1, the detected member 204 is formed from a layer that forms the first wiring 704, but the detected member 204 and the first wiring 704 are formed using an Al—Cu alloy film in which titanium nitride (TiN) with a thickness of about 20 nm is formed on the surface on the opposite side of the vibration plate 109.

In order to obtain an etching end timing by removing part of the inorganic film by dry etching using CF-based gas and forming the region 203, attention is focused on a spectrum of plasma emission originating from N of TiN formed on the uppermost layer of the detected member 204. An emission spectrum indicating a period from a start of reaction of TiN of the detected member 204 to an end of reaction as illustrated in FIG. 10C is detected, and then, after waiting for about 10 sec, the etching is ended. Here, a timing at which the protection film 304 on the detected member 204 is removed and etching of the detected member 204 (TiN) is started corresponds to a timing at which the protection film 304 is removed in the region 203 above the piezoelectric membrane 110 and etching of the second insulating film 604 is started. An etching rate of TiN forming the uppermost layer of the detected member 204 is low as compared with an etching rate of the TEOS oxide film as the second insulating film 604. Thus, by waiting for the etching of TiN with a thickness of 20 nm to end, the TEOS film is removed by a thickness of several times or more of 20 nm.

In this example, a configuration in which a SiN film of the protection film 304 is removed by a thickness of 200 nm, the TEOS oxide film of the second insulating film 604 is removed by a thickness of about 250 nm as inorganic films on the second electrode 302, and the TEOS oxide film of the second insulating film 604 that has a thickness of about 150 nm and the TEOS oxide film of the first insulating film 303 that has a thickness of 400 nm remain on the second electrode 302 is obtained.

In a case where the uppermost layer of the first wiring 704 is formed of Al—Cu, because Al—Cu is hardly etched by etching using CF-based gas used in this example, it is considered to be difficult to detect a peak originating from Al as in Example 1. In this example, the first wiring 704 has a stack structure in which a TiN film that can be etched using CF-based gas is formed on an Al—Cu alloy. With this configuration, it is possible to obtain an etching end timing from a spectrum of plasma emission originating from N of TiN. It is desirable that, as in this example, a combination of the type of gas to be used in etching and a composition of the uppermost layer of the detected member 204 or an elemental species to be detected is appropriately selected.

In the etching using CF-based gas, an etching rate of a TiN film is lower than that of inorganic films (SiN film being the protection film 304, and TEOS oxide film being the second insulating film 604). Thus, by ending the etching after waiting for a decrease of the peak of emission spectrum originating from N of the TiN film a configuration in which the thicknesses of the inorganic films located above the second electrode 302 are reduced, as illustrated in FIG. 14, is obtained with good reproducibility at the same level as Example 1.

### Example 3

In this example, an element substrate and a liquid ejection head described in the first exemplary embodiment are created. In the following description, a point different from Example 1 described above will be mainly described, and the description of a part similar to the above-described configuration will be omitted.

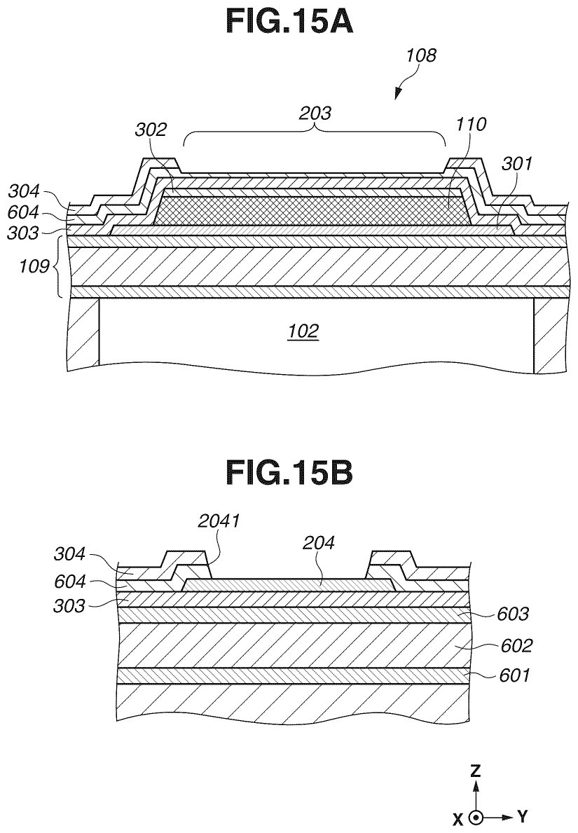

FIG. 15A and FIG. 15B are diagrams illustrating cross sections of the periphery of the piezoelectric element 108 and the detected member 204 after the region 203 is formed according to this example.

In this example, unlike Examples 1 and 2, the detected member 204 is located between the first insulating film 303 and the second insulating film 604 in the direction vertical to the surface of the vibration plate 109. Thus, the detected member 204 is formed using a layer that forms the second wiring 702 located between the first insulating film 303 and the second insulating film 604 in the piezoelectric element 108. With this configuration, it is possible to detect a timing at which the protection film 304 and the second insulating film 604 are removed in the region 203.

An exposed area of one detected member 204 at the opening 2041 is equal to the area of the region 203. In a dry etching process for forming the region 203, chlorine-based etching gas is used. The uppermost layers of the detected member 204 and the second wiring 702 are each an Au—Cu alloy, and detection of an end point of etching is performed using a signal intensity of plasma emission originating from Al.

In the process of etching the protection film 304 (SiN film) and the second insulating film 604 (TEOS oxide film), which are organic layers located above the piezoelectric membrane 110, the etching of an organic layer in an upper layer of the detected member 204 is simultaneously performed. By forming the opening 2041, the detected member 204 is exposed. At the stage where Al—Cu alloy is exposed from the opening 2041 of the detected member 204 by etching and the etching of the Al—Cu alloy film is started, the signal intensity of plasma emission originating from Al starts to increase. At the stage where the signal intensity of Al is stabilized, etching is ended after the state is maintained for about 10 sec.

Because chlorine-based gas is used in etching, the removal of chlorine components is performed. After the end of etching using chlorine-based gas, resist ashing is performed, and then two-fluid cleaning is sufficiently performed so as to completely remove the chlorine components.

In this example, as inorganic films on the second electrode 302, the SiN film of the protection film 304 and the TEOS oxide film of the second insulating film 604 are removed. Furthermore, a configuration in which the TEOS oxide film of the first insulating film 303 is also removed by about 100 nm, and the first insulating film 303 with a thickness of about 300 nm remains on the second electrode 302 is obtained with good reproducibility.

### Example 4

In this example, an element substrate and a liquid ejection head described in the first exemplary embodiment are created. In the following description, a point different from Example 1 described above will be mainly described, and the description of a part similar to the above-described configuration will be omitted.

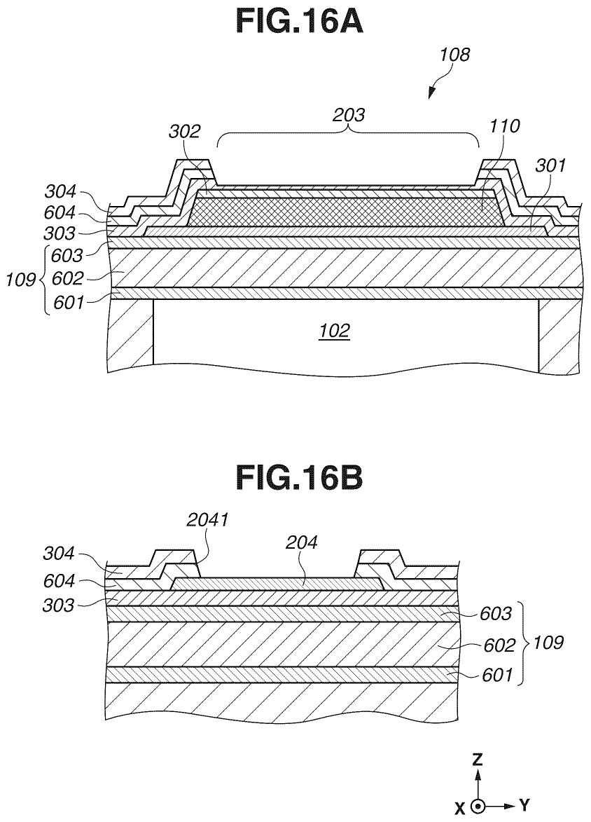

FIG. 16A and FIG. 16B are diagrams illustrating cross sections of the periphery of the piezoelectric element 108 and the detected member 204 after the region 203 is formed according to this example.

In this example, similarly to Example 3, the detected member 204 is located between the first insulating film 303 and the second insulating film 604 in the direction vertical to the surface of the vibration plate 109. The detected member 204 is formed using a layer that forms the second wiring 702.

In the etching process of forming the region 203 by reducing the thickness of an inorganic film on the piezoelectric membrane 110, CF-based etching gas is used similarly to Example 2. The second wiring 702 and the detected member 204 are formed using an Al—Cu alloy film in which a TiN film with a thickness of about 20 nm is formed on the uppermost surface on the opposite side of the vibration plate 109.

The arrangement position of the detected member 204 on the surface of the second flow path substrate 106 is the same as that in Example 1. An exposed area of one detected member 204 is equal to the area of the region 203.

In order to form the region 203 by dry etching using CF-based gas and obtain an etching end timing by reducing the thickness of an inorganic film, attention is focused on a spectrum of plasma emission originating from C of CF-based gas and N of TiN formed on the uppermost layer of the detected member 204. The etching is ended after confirming that an emission intensity starts to decrease after the reaction of TiN of the detected member 204 starts as illustrated in FIG. 10C. Here, a timing at which the protection film 304 and the second insulating film 604 on the detected member 204 are removed and the etching of the detected member 204 (TiN) is started corresponds to a timing at which the protection film 304 and the second insulating film 604 are removed on the second electrode 302 and the etching of the first insulating film 303 is started. An etching rate of a TiN film forming the uppermost layer of the detected member 204 is low as compared with an etching rate of a TEOS oxide film being the first insulating film 303. Thus, by waiting for the etching of TiN with a thickness of 20 nm to end, the first insulating film 303 is removed in the region 203 by a thickness of several times or more of 20 nm. In this example, because etching is ended after confirming the end of etching of TiN of the uppermost layer of the detected member 204, it is possible to make an inorganic film on the second electrode 302 with a small thickness as compared with Example 3.

In this example, a configuration in which, as inorganic films on the second electrode 302, a SiN film of the protection film 304 is removed by a thickness of 200 nm, a TEOS oxide film of the second insulating film 604 is removed by a thickness of 400 nm, a TEOS oxide film of the first insulating film 303 is also removed by a thickness of about 250 nm, and the TEOS oxide film of the first insulating film 303 with a thickness of about 150 nm remains is obtained with good reproducibility.

### Example 5

In this example, an element substrate and a liquid ejection head described in the first exemplary embodiment are created. In the following description, a point different from Example 1 described above will be mainly described, and the description of a part similar to the above-described configuration will be omitted.

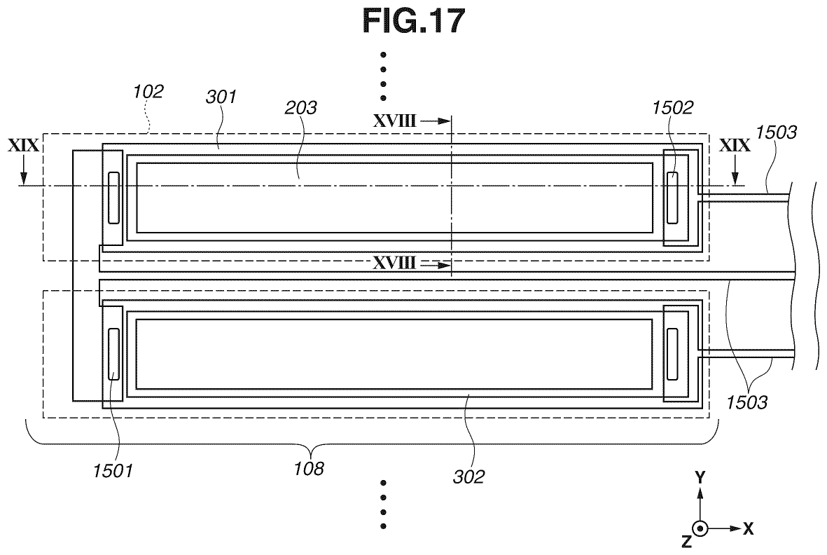

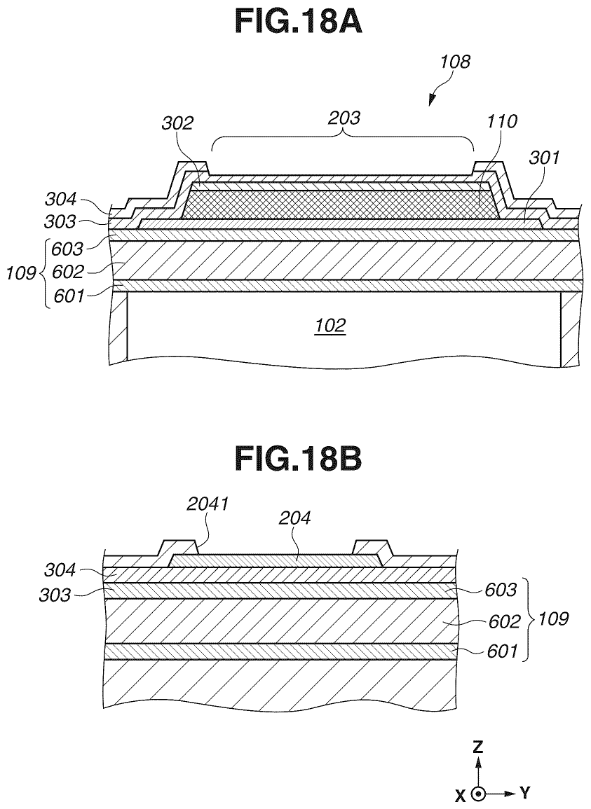

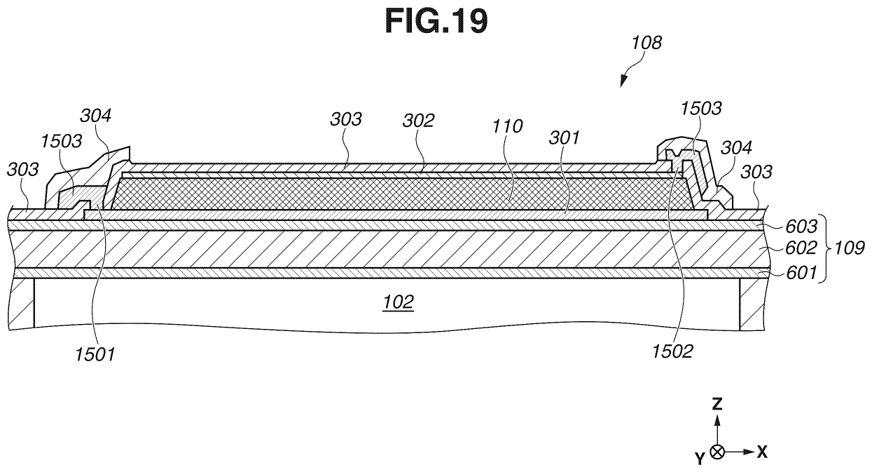

FIG. 17 is a top view of the surface of the second flow path substrate 106 in this example. FIG. 18A and FIG. 18B are diagrams illustrating cross sections of the periphery of the piezoelectric element 108 and the detected member 204 after the region 203 is formed according to this example. The cross-sectional view of the piezoelectric element 108 in FIG. 17 is a cross-sectional view taken along a XVIII-XVIII line in FIG. 17. FIG. 19 is a cross-sectional view of the piezoelectric element 108 taken along a XIX-XIX line in FIG. 17.

Individual ejection elements in this example are arrayed in the Y direction at the density of 150 npi unlike Examples 1 to 4. As the size of the piezoelectric element 108, the size in the X direction (length) is about 500 μm, the size in the Y direction (width) is 110 μm, a diameter of the ejection port 101 is 25 μm, the thickness of the nozzle 1011 communicating with the ejection port 101 is 30 μm, and the thickness of the first flow path substrate 105 is 100 μm. As the size of the pressure chamber 102, the size in the X direction (length) is 550 μm, the size in the Y direction (width) is 120 μm, and the size in the Z direction (height) is 100 μm.

In this example, the configuration differs from a multilayer wiring configuration as in Examples 1 to 4. Two types of wiring connected to the first electrode 301 and the second electrode 302 have a configuration located in the same layer (same height) in the height direction (the Z direction) without being stacked. Thus, it is sufficient that the first insulating film 303 that insulates a wire 1503 and the first electrode 301 is provided, and the second insulating film 604 arranged between the first wiring 704 and the second wiring 702 in the height direction in Examples 1 to 4 is not included.

As illustrated in FIGS. 18A and 19, in the piezoelectric element 108 in this example, a TEOS oxide film with a thickness of 400 nm is formed in the upper layer of the second electrode 302 as the first insulating film 303. The wire 1503 is formed in the upper layer of the first insulating film 303, the first electrode 301 and the wire 1503 are electrically connected by a contact portion 1501, and the second electrode 302 and the wire 1503 are electrically connected by a contact portion 1502. Then, the protection film 304 with a thickness of 200 nm is formed in such a manner as to cover the first insulating film 303 and the wire 1503.

In this example, the detected member 204 is formed using a layer that forms the wire 1503. The wire 1503 and the detected member 204 are formed using an Al—Cu alloy film in which a TiN film with a thickness of about 20 nm is formed on the surface on the opposite side of the vibration plate 109. An exposed area of one detected member 204 is equal to the area of the region 203.

In the etching process of forming the region 203 by removing at least part of the inorganic films in the upper layer of the second electrode 302 (the protection film 304 and the first insulating film 303), similarly to Examples 2 and 4, CF-based etching gas is used. If a SiN film as the protection film 304 is etched, TiN is exposed in the superficial layer of the detected member 204. When the TiN is etched using CF-based gas, attention is focused on a spectrum of plasma emission originating from C of CF-based gas and N of TiN formed on the uppermost layer of the detected member 204. The etching is ended after detecting the start of a reaction of TiN located on the uppermost layer of the detected member 204 and waiting for about 10 sec after confirming a clear rising of an emission intensity as illustrated in FIG. 10C. That is, etching is promptly ended at a stable timing at which the etching of the TiN film is started. With this configuration, as illustrated in FIG. 17, a configuration in which, as inorganic films on the second electrode 302, a SiN film of the protection film 304 is removed by a thickness of 200 nm, a TEOS oxide film of the first insulating film 303 is removed by a thickness of about 100 nm, and the TEOS oxide film of the first insulating film 303 that has a thickness of 300 nm remains is obtained with good reproducibility.

### Example 6

In this example, an element substrate and a liquid ejection head described in the second exemplary embodiment are created. In the following description, a point different from Example 1 described above will be mainly described, and the description of a part similar to the above-described configuration will be omitted.

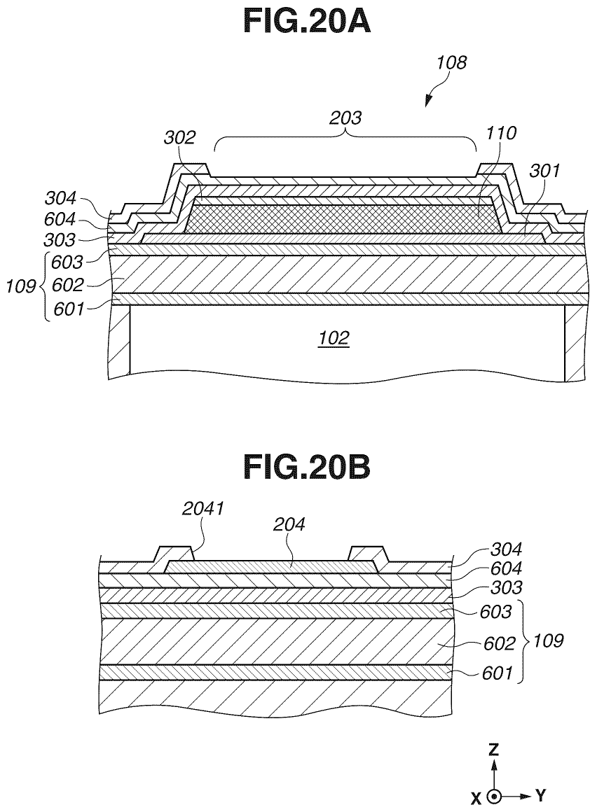

FIG. 20A and FIG. 20B are diagrams illustrating cross sections of the periphery of the piezoelectric element 108 and the detected member 204 after the region 203 is formed in this example. The cross-sectional view of the piezoelectric element 108 in FIG. 20A is a cross-sectional view at a position corresponding to a XX-XX line in FIG. 12.

In this example, the detected member 204 is located between the protection film 304 and the second insulating film 604 in the direction vertical to the surface of the vibration plate 109. Thus, the detected member 204 is formed using a layer that forms the first wiring 704 located between the protection film 304 and the second insulating film 604 in the piezoelectric element 108. Similarly to the detected member 204, the pad portion 202 is formed using a layer that forms the first wiring 704. The first wiring 704, the detected member 204, and the pad portion 202 are formed using an Al—Cu alloy film. An exposed area of one detected member 204 is equal to an exposed area of the pad portion 202 from the protection film 304.

Inorganic films (the protection film 304, the first insulating film 303, and the second insulating film 604) located above the second electrode 302, the pad portion 202, and the detected member 204 are etched in the same process. In this example, chlorine-based etching gas is used. If a SiN film as the protection film 304 on the uppermost layer is etched, an Al—Cu alloy film serving as an uppermost layer of the detected member 204 and the pad portion 202 are exposed. At the stage where the etching of the Al—Cu alloy film is started, a signal intensity of plasma emission originating from Al starts to increase. Etching is ended after the state is maintained for about 10 sec after the signal intensity of Al has started to increase. With this configuration, a state in which the Al—Cu alloy film of the detected member 204 and the pad portion 202 is exposed.

Because chlorine-based gas is used in the etching, the removal of chlorine components is performed. After the end of etching using chlorine-based gas, resist ashing is performed, and then two-fluid cleaning is sufficiently performed so as to completely remove the chlorine components.

In this example, as illustrated in FIG. 20A, a SiN film of the protection film 304 and a TEOS oxide film of the second insulating film 604 are removed by 100 nm as inorganic films on the second electrode 302. A configuration in which the second insulating film 604 with a thickness of about 300 nm, and the first insulating film 303 with a thickness of 400 nm remain on the second electrode 302 is obtained with good reproducibility.

### Example 7

In this example, an element substrate and a liquid ejection head described in the second exemplary embodiment are created. In the following description, a point different from Example 6 described above will be mainly described, and the description of a part similar to the configuration of Example 6 will be omitted.

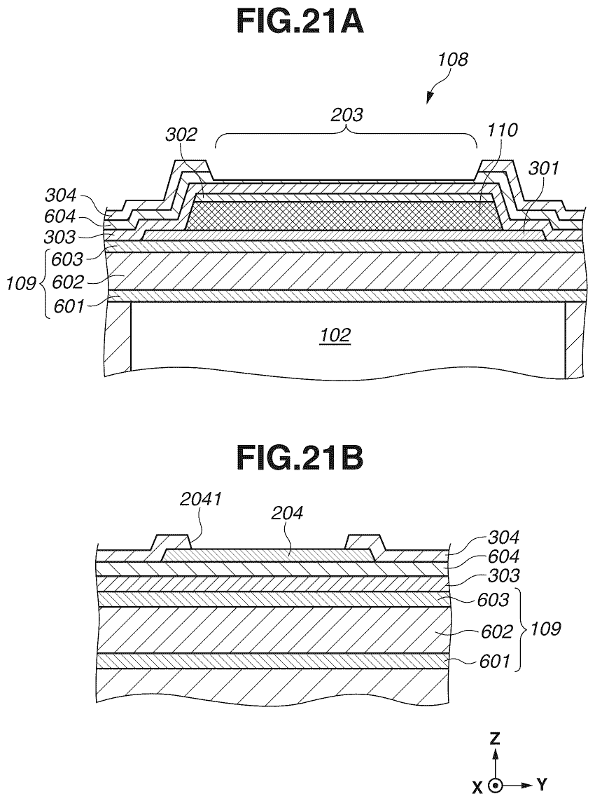

FIG. 21A and FIG. 21B are diagrams illustrating cross sections the piezoelectric element 108 and the detected member 204 in this example. The cross-sectional view of the piezoelectric element 108 in FIG. 21A is a cross-sectional view at a position corresponding to a XX-XX line in FIG. 12.

In this example, similarly to Example 6, the detected member 204 is located between the protection film 304 and the second insulating film 604 in the direction vertical to the surface of the vibration plate 109. Thus, the detected member 204 is formed using a layer that forms the first wiring 704 located between the first insulating film 303 and the second insulating film 604 in the piezoelectric element 108. Similarly to the detected member 204, the pad portion 202 is formed using the layer that forms the first wiring 704. The first wiring 704, the detected member 204, and the pad portion 202 are formed using an Al—Cu alloy film. Unlike Example 6, the wire 1503 and the detected member 204 are formed using an Al—Cu alloy film in which a TiN film with a thickness of about 20 nm is formed on the surface on the opposite side of the vibration plate 109. An exposed area of one detected member 204 is equal to an exposed area of the pad portion 202 from the protection film 304. That is, the detected member 204 and the pad portion 202 are arranged in a layer at the same height as the first wiring 704 as a wire in an upper layer.

The inorganic films located above the second electrode 302, the pad portion 202, and the detected member 204 are etched in the same process. In this example, CF-based etching gas is used. If a SiN film as the protection film 304 on the uppermost layer is etched, the detected member 204, and a TiN film serving as an uppermost layer of the pad portion 202 are exposed. When the TiN film is etched using CF-based gas, a spectrum of plasma emission originating from N of TiN can be used to detect the end of the etching. The start and end of a reaction are detected from the increase and the decrease in the emission spectrum originating from N of TiN of the detected member 204 as illustrated in FIG. 10C, and after waiting for about 10 sec, the etching is ended. With this configuration, a state in which the TiN film above the pad portion 202 is removed, and an Al—Cu alloy film of the detected member 204 and the pad portion 202 is exposed is obtained.

An etching rate of the TiN film using CF-based gas is low as compared with a TEOS film forming the second insulating film 604. For this reason, by ending the etching at a timing at which the TiN film is etched and the spectrum is stabilized, in the region 203 above the second electrode 302, the inorganic films (the protection film 304 and the second insulating film 604) can be removed by a thickness greater than the thickness of the layer, i.e., the protection film 304, formed on the detected member 204. In this example, as illustrated in FIG. 21A, in the region 203 above the second electrode 302, a SiN film of the protection film 304 is removed by a thickness of 200 nm, and a TEOS oxide film of the second insulating film 604 is removed by a thickness of 250 nm. A configuration in which the second insulating film 604 with a thickness of 150 nm and the first insulating film 303 remain on the second electrode 302 is obtained with good reproducibility. In this manner, in this example, it is possible to reduce the thicknesses of an inorganic film on the second electrode 302 in the region 203 as compared with Example 6.

### Example 8

In this example, an element substrate and a liquid ejection head described in the second exemplary embodiment are created. In the following description, a point different from Example 5 described above will be mainly described, and the description of a part similar to the above-described configuration will be omitted.

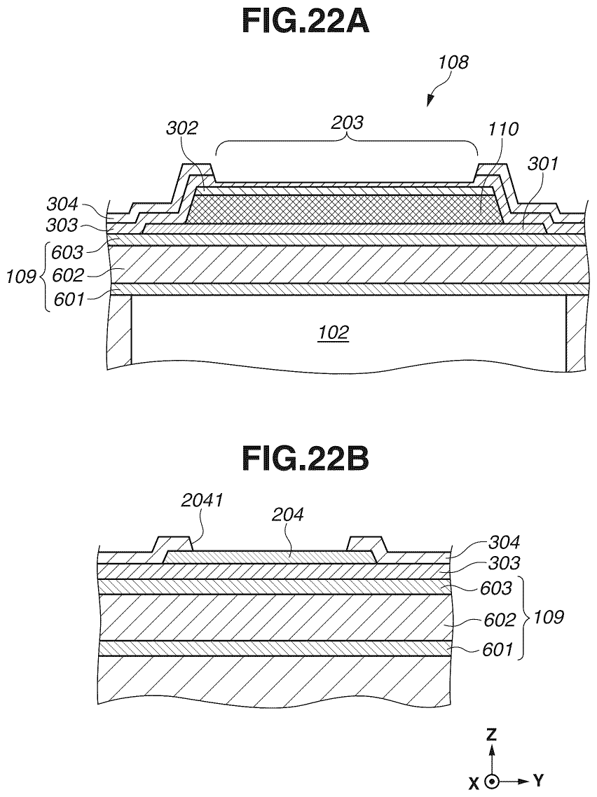

A schematic top view of a second flow path substrate 106 in this example is similar to that in Example 5 and FIG. 17. FIG. 22A and FIG. 22B are diagrams illustrating cross sections of the piezoelectric element 108 and the detected member 204 in this example. The cross-sectional view of the piezoelectric element 108 in FIG. 22A is a cross-sectional view at a position corresponding to a XX-XX line in FIG. 12.

Unlike Examples 1 to 4 and 6 to 7, individual ejection elements are arrayed in the Y direction at the density of 150 npi similarly to Example 5. Similarly to Example 5, as the size (dimension) of the piezoelectric element 108, the size in the X direction (length) is about 500 μm, the size in the Y direction (width) is 110 μm. A diameter of the ejection port 101 is about 25 μm, the thickness of the nozzle 1011 communicating with the ejection port 101 is 30 μm, and the thickness of the first flow path substrate 105 is 100 μm. As the size of the pressure chamber 102, the size in the X direction (length) is 550 μm, the size in the Y direction (width) is 120 μm, and the size in the Z direction (height) is 100 μm.

In this example, the configuration differs from a multilayer wiring configuration as in Examples 1 to 4 and 6 to 7. Two types of wiring connected to the first electrode 301 and the second electrode 302 have a configuration located in the same layer (same height) in the height direction (the Z direction) direction without being stacked. Thus, it is sufficient that the first insulating film 303 that insulates a wire 1503 and the first electrode 301 is provided, and the second insulating film 604 arranged between the first wiring 704 and the second wiring 702 in the height direction in Examples 1 to 4 and 6 to 7 is not included.

In this example, the detected member 204 is formed using a layer that forms the wire 1503. The wire 1503 and the detected member 204 are formed using an Al—Cu alloy film in which a TiN film with a thickness of about 20 nm is formed on the surface on the opposite side of the vibration plate 109. An exposed area of one detected member 204 is equal to an exposed area of the pad portion 202 from the protection film 304 unlike Example 5.

In the etching process of forming the region 203 by removing at least part of the inorganic films in the upper layer of the second electrode 302 (the protection film 304 and the first insulating film 303), CF-based etching gas is used. If a SiN film as the protection film 304 is etched, TiN is exposed in the superficial layer on the detected member 204 side. When the TiN is etched using CF-based gas, attention is focused on a spectrum of plasma emission originating from N of TiN. In this example, etching is ended after detecting the start of a reaction of TiN on the uppermost layer of the detected member 204, and furthermore, after confirming the decrease in the N emission intensity of TiN as illustrated in FIG. 10C. After the etching is ended, a state in which TiN is removed and the Al—Cu alloy film is exposed is obtained in the pad portion 202. An etching rate of TiN is low as compared with an etching rate of a TEOS oxide film. Thus, a configuration in which, as inorganic films on the second electrode 302, a SiN film of the protection film 304 is removed by a thickness of 200 nm, a TEOS oxide film of the first insulating film 303 is removed by a thickness of about 250 nm, and the TEOS oxide film of the first insulating film 303 that has a thickness of 150 nm remains is obtained with good reproducibility.

According to the exemplary embodiments of the present disclosure, it is possible to stably reduce the thickness of a protection film covering a membrane-type piezoelectric element, and stably provide a liquid ejection head including a piezoelectric element with a desired displacement amount.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-222826, filed Dec. 28, 2023, which is hereby incorporated by reference herein in its entirety.

What is claimed is:

1. A manufacturing method of a liquid ejection head including an element substrate including a piezoelectric element including a first electrode, a piezoelectric membrane, and a second electrode on a surface of a substrate in this order, wiring connected to the piezoelectric element, a terminal for supplying an electric signal for driving the piezoelectric element and connected to the wiring, an inorganic structure arranged at a position not overlapping the piezoelectric element, the wiring, and the terminal when viewed from a direction vertical to the surface of the substrate, and a protection film that covers at least the piezoelectric element, the wiring, and the inorganic structure, the manufacturing method comprising:
etching the protection film to form a region in which part of the protection film overlapping the piezoelectric element is removed, and to form an opening in which the protection film overlapping the inorganic structure is removed to expose a part of the inorganic structure.

2. The manufacturing method of the liquid ejection head according to claim 1, wherein, in the etching of the protection film, the etching is ended at a time point at which the inorganic structure is exposed from the formed opening.

3. The manufacturing method of the liquid ejection head according to claim 1, including patterning a film to form the wiring and the inorganic structure.

4. The manufacturing method of the liquid ejection head according to claim 1,
wherein the etching is dry etching, and
wherein, in the etching of the protection film, exposure of the inorganic structure is detected by detecting a change in a signal intensity of a plasma emission spectrum.

5. The manufacturing method of the liquid ejection head according to claim 3,
wherein the wiring includes first wiring electrically connected with the first electrode, and second wiring electrically connected with the second electrode, and
wherein the inorganic structure is formed simultaneously with at least either one of the first wiring or the second wiring.

6. The manufacturing method of a liquid ejection head according to claim 5, including patterning a film to form the first wiring, the second wiring, and the inorganic structure.

7. The manufacturing method of the liquid ejection head according to claim 5, wherein the wiring has a multilayer wiring configuration, and the first wiring and the second wiring are located in layers different from each other in the direction vertical to the surface of the substrate.

8. The manufacturing method of the liquid ejection head according to claim 1, wherein an exposed area of the inorganic structure from one opening in a direction parallel to the surface is 0.5 times or more and 2 times or less of an area of the region corresponding to one piezoelectric element.

9. The manufacturing method of a liquid ejection head according to claim 1,
wherein the terminal is exposed from the protection film, and
wherein an exposed area of the inorganic structure from one opening in a direction parallel to the surface is 0.5 times or more and 2 times or less of an exposed area of the terminal.

10. The manufacturing method of a liquid ejection head according to claim 1, wherein the etching forms a plurality of the openings.

11. The manufacturing method of a liquid ejection head according to claim 10, wherein a total area of the plurality of the openings in a direction parallel to the surface constitutes 5% or more of an area of the element substrate.

12. The manufacturing method of a liquid ejection head according to claim 1, wherein the inorganic structure includes any of gold (Au), aluminum (Al), platinum (Pt), iridium (Ir), an Al compound, a titanium (Ti) compound, a tantalum (Ta) compound, and a tungsten (W) compound.

13. A liquid ejection head comprising:
an element substrate including a piezoelectric element including a first electrode, a piezoelectric membrane, and a second electrode on a surface of a substrate in this order, wiring connected to the piezoelectric element, a terminal for supplying an electric signal for driving the piezoelectric element and connected to the wiring, and a protection film that covers at least at least the piezoelectric element and the wiring,
wherein the protection film includes a region in which part of the protection film overlapping the piezoelectric element in a direction vertical to the surface of the substrate is removed, and
wherein an inorganic structure is arranged at a position not overlapping the piezoelectric element, the wiring, and the terminal when viewed from the direction vertical to the surface of the substrate, and the inorganic structure is exposed from an opening of the protection film.

14. The liquid ejection head according to claim 13, wherein the wiring is multilayer wiring including first wiring electrically connected with the first electrode, and second wiring electrically connected with the second electrode.

15. The liquid ejection head according to claim 14, wherein the inorganic structure is located at a same height as at least either one of the first wiring or the second wiring in the direction vertical to the surface of the substrate.

16. The liquid ejection head according to claim 14, wherein the inorganic structure is located at a same height as the first electrode in the direction vertical to the surface of the substrate.

17. The liquid ejection head according to claim 13, wherein an exposed area of the inorganic structure from one opening in a direction parallel to the surface is 0.5 times or more and 2 times or less of an area of the region corresponding to one piezoelectric element.

18. The liquid ejection head according to claim 13,
wherein the terminal is exposed from the protection film, and
wherein an exposed area of the inorganic structure from one opening in a direction parallel to the surface is 0.5 times or more and 2 times or less of an exposed area of the terminal.

19. The liquid ejection head according to claim 19, wherein the inorganic structure includes any of gold (Au), aluminum (Al), platinum (Pt), iridium (Ir), an Al compound, a titanium (Ti) compound, a tantalum (Ta) compound, and a tungsten (W) compound.

20. The liquid ejection head according to claim 13, wherein the inorganic structure is formed of a material that is the same as a material of the wiring or of the first electrode.
